(19) United States
(12) Patent Application Publication
(10) Pub. No.: US 2018/0300802 A1
(43) Pub. Date: Oct. 18, 2018

(54) FACILITY IMAGING DEVICE, FACILITY IMAGE COLLECTING DEVICE, FACILITY IMAGE STORAGE DEVICE, FACILITY IMAGE OUTPUT CONTROL DEVICE, FACILITY OPERATION SUPPORT DEVICE, USER TERMINAL DEVICE, AND FACILITY OPERATION SUPPORT METHOD

(71) Applicant: PANASONIC INTELLECTUAL PROPERTY MANAGEMENT CO., LTD., Osaka (JP)

(72) Inventors: Kouhei NISHINO, Tokyo (JP); Tetsurou KAKIZAWA, Kanagawa (JP)

(73) Assignee: PANASONIC INTELLECTUAL PROPERTY MANAGEMENT CO., LT D., Osaka (JP)

(21) Appl. No.: 15/769,102

(22) PCT Filed: Aug. 8, 2016
(86) PCT No.: PCT/JP2016/003646

§ 371 Date: Apr. 18, 2018

(30) Foreign Application Priority Data
Oct. 30, 2015 (JP) 2015-214986
Oct. 30, 2015 (JP) 2015-214994

(51) Int. Cl. G06Q 30/06; H04N 7/18; G06T 7/00

(52) U.S. Cl. CPC G06Q 30/0643; G06T 7/00; H04N 7/18

(57) ABSTRACT

Facility imaging device and method reduces a load of traffic on a network when collecting images that result from image-capturing the insides. The facility imaging device including a capture that image-captures the inside of a facility and sequentially outputs captured images that temporally follow one another; a processor that performs image processing on the captured images and outputs processed images; and a communicator that transmits the processed images to an image recording server through the network. Whenever the captured image is input from the capture, the processor updates dominant image information and generates a reading still image that results from removing a moving object, as a processed image. The communicator transmits the reading still image at a prescribed timing. Furthermore, a reading screen is delivered from a facility operation support device to a user terminal device and thus the reading screen is displayed on the user terminal device.

### TECHNICAL FIELD

The present disclosure relates to a facility imaging device that provides an image that results from image-capturing the inside of a facility, to a facility image collecting device through a network, a facility image collecting device that acquires the image that results from image-capturing the inside of the facility, from the facility imaging device through the network and that stores the image, a facility image storage device that not only stores an image which is output from the facility imaging device that image-captures the inside of the facility, but also outputs the image to the facility image collecting device through the network, a facility image output control device that is connected to the facility imaging device which image-captures the inside of the facility, and controls image output to the facility image collecting device through the network, a facility operation support device that supports business of a user who operates a facility which provides a commodity or a service to a customer, a user terminal device, and a facility operation support method.

### BACKGROUND ART

Monitoring systems in which a camera that image-captures the inside of a store is installed in the store such as a convenience store and a situation of each store is monitored with a picture from the camera have come in wide use. However, a sales room in which display shelves are arranged is image-captured with the camera that is installed in this type of store, and an actual situation of the sales room, such as a display situation of a commodity, is set to be monitored based on the image. When this is done, a matter that has to be improved for a commodity management job is known and thus and the business of efficiently performing an action for improvement can be conducted.

Furthermore, in a store operation system in which many stores such as convenience stores are operated, a supervisor who belongs to headquarters that generally control the stores knows situations of the stores and provides a counseling or a proposal to a store manager while making visits to the stores. However, in recent years, the number of stores of which one supervisor is in charge has increased, and a variation in the situation of each store has occurred. Because of this, a technology is desirable in which the supervisor can efficiently conduct the business of operating each store is desirable. Furthermore, in some cases, one owner manages many stores. For this owner as well as the supervisor, the efficiency of the business of operating a store is desirable.

In a case where the image from the camera is used in this manner for improving the commodity management job, in some cases, a customer or store staff that stays before the display shelf is an obstacle and thus a display situation of the display of the commodity cannot be suitably known from the image. For that reason, as a technology of solving this problem, in the related art, the technology has been known in which correction processing that removes the obstacle which covers a monitoring target is performed on many still images that are captured by a digital camera at a prescribed time interval and in which a face-up situation of the commodity display shelf in the convenience store or the like is efficiently monitored (refer to PTL 1).

Furthermore, as a technology that is associated with the business of managing the store, which is conducted by the supervisor or the owner that operates many stores, in the related art, the technology has been known in which indoor and outdoor situations in a plurality of stores such as franchise chain (FC) member stores are remotely monitored with a monitoring camera and a microphone and in which various pieces of information necessary for management of the store, which is created based on image data from the monitoring camera and audio data from the microphone, are provided, as pieces of management counseling information, on line to headquarters such as FC headquarters (refer to PTL 2).

Furthermore, the technology has known in which any sales room is selected from among a plurality of sales rooms, in which a list of pictures of a sales room during every time span at a date and time that is set and sales data are displayed, and in which a situation of the sales room during every time span and transition of sales can be known (refer to PTL 3).

### CITATION LIST

### Patent Literature

PTL 1: Japanese Patent No. 4456437

PTL 2: Japanese Patent Unexamined Publication No. 2002-366621

PTL 3: Japanese Patent No. 5072985

### SUMMARY OF THE INVENTION

According to an aspect of the present disclosure, there is provided a facility imaging device that provides an image which results from image-capturing the inside of a facility, to a facility image collecting device through a network, which is set to be configured to include a capture that image-captures the inside of the facility and sequentially outputs the captured images that temporally follow one another; a processor that performs image processing on the captured images and outputs the processed images; and a communicator that transmits the processed images to the facility image collecting device through the network, in which, whenever the captured image is input from the capture, the processor updates dominant image information and generates a reading still image that results from removing a moving object, as the processed image, and in which the communicator transmits the reading still image at a prescribed timing.

Furthermore, according to another aspect of the present disclosure, there is provided a facility image collecting device that acquires an image which results from image-capturing the inside of a facility, from a facility imaging device through a network and that stores the acquired image, which is set to be configured to include a communicator that receives a reading still image which is transmitted from the facility imaging device; a storage device that stores the reading still image; and a processor that controls a timing at which the reading still image is acquired from the facility imaging device, in which the communicator makes an image transmission request periodically at a prescribed timing under the control of the processor, and, receives the reading still image that is transmitted from the facility imaging device according to the image transmission request.

Furthermore, according to still another aspect of the present disclosure, there is provided a facility image storage device that not only stores an image which is output from a facility imaging device that image-captures the inside of a facility, but also outputs the image to a facility image collecting device through a network, which is set to be configured to include a receiver that receives captured images that temporally follow one another, which are sequentially output from the facility imaging device; a storage device that stores the captured images; a processor that performs image processing on the captured images and outputs the processed images; and a transmitter that transmits the processed mages to the facility image collecting device through the network, in which whenever the captured image is input from the facility imaging device, the processor updates dominant image information and generates a reading still image that results from removing a moving object, as the processed image, and in which the transmitter transmits the reading still image at a prescribed timing.

Furthermore, according to still another aspect of the present disclosure, there is provided a facility image output control device that is connected to a facility imaging device which image-captures the inside of a facility and that controls image output to a facility image collecting device through a network, which is set to be configured to include a receiver that receives captured images which temporally follow one another, which are sequentially output from the facility imaging device; a processor that performs image processing on the captured images and outputs processed images; and a transmitter that transmits the processed images to a facility image collecting device through the network, in which, whenever the captured images are input from the facility imaging device, the processor updates dominant image information and generates a reading still image that results from a moving object, as the processed image, and in which the transmitter transmits the reading still image at a prescribed timing.

Furthermore, according to still another aspect of the present disclosure, there is provided a facility operation support device that supports business of a user who operates a facility which provides a commodity or a service to a customer, which is set to be configured to include an image storage that stores an area image of each area in the facility; a management server that manages the area image; and a delivery server that delivers a reading screen including the area image to a user terminal device, in which the delivery server generates the reading screen which includes a facility-based image list in which the area image of every facility relating to the area that is shared is shown side by side with a facility name, and an area selection menu for changing the area in the facility-based image list, and delivers the generated reading screen to the user terminal device.

Furthermore, according to still another aspect of the present disclosure, there is provided a user terminal device that displays a screen based on information which is delivered from a facility operation support device that supports business of a user who operates a facility that provides a commodity or a service to a customer, which is set to be configured to display a reading screen that includes a facility-based image list in which an area image of every facility relating to an area that is shared is shown side by side with a facility name and an area selection menu for changing the area in the facility-based image list.

Furthermore, according to still another aspect of the present disclosure, there is provided a facility operation support method that supports business of a user who operates a facility which provides a commodity or a service to a customer, using an information processing device, which is set to have a configuration in which the information processing device stores an area image of each area in the facility, generates a reading screen which includes a facility-based image list in which an area image of every facility relating to the area that is shared is shown side by side with a facility name, and an area selection menu for changing the area in the facility-based image list, and delivers the generated reading screen to a user terminal device.

According to the present disclosure, because, among the reading still images that are sequentially generated, only the reading still image at the prescribed timing is transmitted, an amount of communication can be suppressed. Furthermore, because the reading still image that results from removing the moving object such as a person is output, privacy can be protected. Accordingly, in the facility image collecting device, not only can a load of traffic on the network when collecting images that result from image-capturing the insides of a plurality of facilities be reduced, but a risk that an unprocessed image will leak out can also be removed and thus the privacy-protected image can be efficiently collected.

According to the present disclosure, the reading screen is delivered to the user terminal device and the facility-based image list that is included in the reading screen is available. Thus, the situation of the area can be simply compared with those of facilities, with the shared area being set to be a target. Furthermore, with the area selection menu, situations of different areas can be compared with those of a plurality of facilities by changing the area in the facility-based image list. Accordingly, even in a case where the number of facilities or the number of areas increases, a plurality of users can efficiently check the situation of the inside of the facility from anywhere, and can reasonably conduct the business for facility operation improvement.

### BRIEF DESCRIPTION OF DRAWINGS

FIG. 1 is a diagram of an entire configuration of a facility operation support system according to the present embodiment.

FIG. 2 is a plan-view diagram of a store for describing a layout of the store and an installation situation of camera 1.

FIG. 3 is a block diagram illustrating schematic configurations of camera 1, image recording server 21, management server 22, and delivery server 23.

FIG. 4 is a descriptive diagram illustrating a transition situation of a screen that is generated in delivery server 23 and is displayed on PC 3.

FIG. 5 is a descriptive diagram illustrating a store list comparison screen.

FIG. 6 is a descriptive diagram illustrating a sales room list checking screen.

FIG. 7 is a descriptive diagram illustrating a designation point-in-time checking screen.

FIG. 8 is a descriptive diagram illustrating an all-day checking screen.

FIG. 9 is a descriptive diagram illustrating an enlargement image display screen.

FIG. 10 is a descriptive diagram illustrating a store-based image display screen at the time of enlargement image reading.

FIG. 11 is a descriptive diagram illustrating an enlargement image editing screen.

FIG. 12 is a descriptive diagram illustrating a report input screen.

FIG. 13 is a descriptive diagram illustrating a report list screen.

FIG. 14 is a descriptive diagram illustrating the report list screen in a detailed display state.

FIG. 15 is a descriptive diagram illustrating the enlargement image display screen at the time of report reading.

FIG. 16 is a descriptive diagram illustrating a message display screen.

FIG. 17 is a descriptive diagram illustrating a user setting screen.

FIG. 18 is a descriptive diagram illustrating a topic setting screen.

FIG. 19 is a descriptive diagram illustrating the topic display screen.

FIG. 20 is a descriptive diagram illustrating a monitoring screen that is displayed on smartphone 4.

FIG. 21 is a descriptive diagram illustrating an enlargement display situation of a sales room image on the monitoring screen.

FIG. 22 is a block diagram illustrating schematic configurations of camera 221 and recorder 231 according to a modification example of the facility operation support system.

FIG. 23 is a block diagram illustrating schematic configurations of camera 241 and recorder 251 according to the modification example of the facility operation support system.

FIG. 24 is a block diagram illustrating schematic configurations of camera 241 and adaptor 261 according to the modification example of the facility operation support system.

### DESCRIPTION OF EMBODIMENTS

Problems in the related art are briefly described before describing an embodiment. According to the technology that is disclosed in PTL 1, by periodically collecting an image that results from image-capturing a sales room in a convenience store or the like and removing an obstruction such as a shopper or a store staff from the image, it is possible that an actual situation of a sales room for every time span is suitable checked. Furthermore, according to the technology that is disclosed in PTL 2, management counseling information (store clerk information, commodity display information, commodity shortage information, commodity inventory information, visitor information and the like) that is necessary for providing counseling on management of a store can be acquired from a remote location where FC headquarters or the like of the convenience store or the like is located, and a workload of a supervisor can be greatly reduced. Furthermore, as disclosed in PTL 3, by building a live camera that is capable of acquiring an image of every sales room into a POS system, it is possible that an actual circumstance of the sales room is checked for every time span without making visits to sales rooms one by one.

However, in the related art, a mechanism is employed in which a server collects an original image from a plurality of stores at a remote location through a network and a correction image is created in a center server. Because of this, when collecting the original image, there is a likelihood that a load of traffic on the network will increase, communication will be unstable, or communication will be impossible.

Furthermore, there is a risk that an unprocessed image on which processing that removes the shopper, the store staff or the like that appears on the original image is not performed will leak out, and it is desirable that an improvement is made from the point of view of privacy protection. However, in the related art, no consideration is given to the problem of the leakage of the unprocessed, and there is a problem in that the risk that the unprocessed image will leak out cannot be sufficiently reduced.

Furthermore, in the related art, the convenience that a situation of the sales room or the like can be monitored from a remote location is provided. However, no consideration is given to a mechanism in which, even in a case where the number of stores or the number of sales rooms increases, a plurality of users, such as supervisors and owners who manage many stores, check situations of the insides of the stores efficiently, and there is a problem in that the business of improving store operation cannot be reasonably conducted.

For that reason, the present disclosure is for providing a facility imaging device, a facility image collecting device, a facility image storage device, and a facility image output control device that are capable of not only reducing a load of traffic on a network when collecting images that result from image-capturing the insides of a plurality of facilities, but also removing a risk that an unprocessed image will leak out and efficiently collecting images that are privacy-protected.

Furthermore, the present disclosure is for providing a facility operation support device, a user terminal device, and a facility operation support method that, even in a case where the number of stores or the number of sales rooms increases, are capable of enabling a plurality of users such as supervisors or owners that manage many stores to efficiently check a situation of the inside of a store from anywhere and to conduct reasonably the business of improving the store operation.

According to a first disclosure that was made to solve the problems described above, a facility imaging device that provides an image which results from image-capturing the inside of a facility, to a facility image collecting device through a network is set to be configured to include a capture that image-captures the inside of the facility and sequentially outputs the captured images that temporally follow one another; a processor that performs image processing on the captured images and outputs the processed images; and a communicator that transmits the processed images to the facility image collecting device through the network, in which, whenever the captured image is input from the capture, the processor updates dominant image information and generates a reading still image that results from removing a moving object, as the processed image, and in which the communicator transmits the reading still image at a prescribed timing.

Accordingly, because, among the reading still images that are sequentially generated, only the reading still image at the prescribed timing is transmitted, an amount of communication can be suppressed. Furthermore, because the reading still image that results from removing the moving object such as a person is output, privacy can be protected. Accordingly, in the facility image collecting device, not only can a load of traffic on the network when collecting images that result from image-capturing the insides of a plurality of facilities be reduced, but a risk that an unprocessed image will leak out can also be removed and thus the privacy-protected image can be efficiently collected.

Furthermore, according to a second disclosure, a configuration in which the dominant image information is color information on a per-pixel basis is set to be employed.

Accordingly, the reading still image that results from removing the moving object can be efficiently generated.

Furthermore, according to a third disclosure, a configuration in which the communicator transmits the reading still image according to an image transmission request that is transmitted from the facility image collecting device at a timing that is common to other facility imaging devices is set to be employed.

Accordingly, the facility image collecting device, the reading still image at the timing that is common to a plurality of facility imaging devices can be collected. For this reason, when the reading still images that result from the plurality of facility imaging devices are screen-displayed in a state of being arranged side by side, situations of the insides of the facilities at the timing that is common to the plurality of facilities can be compared with each other.

Furthermore, according to a fourth disclosure, a configuration in which communicator not only outputs the reading still image that results from removing the moving object to an image storage device for facility operation support, but also outputs an unprocessed image that result from not removing the moving object to another image storage device in which security is ensured is set to be employed.

Accordingly, the reading still image that is output from the facility imaging device and the unprocessed image each can be used for application in store management such as commodity control and for application in crime prevention and disaster prevention.

Furthermore, according to a fifth disclosure, a facility image collecting device that acquires an image which results from image-capturing the inside of a facility, from a facility imaging device through a network and that stores the acquired image is set to be configured to include a communicator that receives a reading still image which is transmitted from the facility imaging device; a storage device that stores the reading still image; and a processor that controls a timing at which the reading still image is acquired from the facility imaging device, in which the communicator makes an image transmission request periodically at a prescribed timing under the control of the processor, and, receives the reading still image that is transmitted from the facility imaging device according to the image transmission request.

Accordingly, in the same as in the first disclosure, in the facility image collecting device, not only can the load of traffic on the network when collecting images that result from image-capturing the insides of the plurality of facilities be reduced, but the risk that the unprocessed image will leak out can also be removed and thus the privacy-protected image can be efficiently collected.

Furthermore, according to a sixth disclosure, a configuration in which when acquisition of the reading still image fails at the timing, the communicator repeatedly makes the image transmission request for a duration up to the next timing until the acquisition of the reading still image succeeds is set to be employed.

Accordingly, a slight time difference occurs, but the reading still image at every prescribed timing can be collected without being leaked.

Furthermore, according to a seventh disclosure, a facility image storage device that not only stores an image which is output from a facility imaging device that image-captures the inside of a facility, but also outputs the image to a facility image collecting device through a network is set to be configured to include a receiver that receives captured images that temporally follow one another, which are sequentially output from the facility imaging device; a storage device that stores the captured images; a processor that performs image processing on the captured images and outputs the processed images; and a transmitter that transmits the processed images to the facility image collecting device through the network, in which whenever the captured image is input from the facility imaging device, the processor updates dominant image information and generates a reading still image that results from removing a moving object, as the processed image, and in which the transmitter transmits the reading still image at a prescribed timing.

Accordingly, in the same as in the first disclosure, in the facility image collecting device, not only can the load of traffic on the network when collecting images that result from image-capturing the insides of the plurality of facilities be reduced, but the risk that the unprocessed image will leak out can also be removed and thus the privacy-protected image can be efficiently collected.

According to an eighth disclosure, a facility image output control device that is connected to a facility imaging device which image-captures the inside of a facility and that controls image output to a facility image collecting device through a network, is set to be configured to include a receiver that receives captured images which temporally follow one another, which are sequentially output from the facility imaging device; a processor that performs image processing on the captured images and outputs processed images; and a transmitter that transmits the processed images to the facility image collecting device through the network, in which, whenever the captured images are input from the facility imaging device, the processor updates dominant image information and generates a reading still image that results from a moving object, as the processed image, and in which the transmitter transmits the reading still image at a prescribed timing.

Accordingly, in the same as in the first disclosure, in the facility image collecting device, not only can the load of traffic on the network when collecting images that result from image-capturing the insides of the plurality of facilities be reduced, but the risk that the unprocessed image will leak out can also be removed and thus the privacy-protected image can be efficiently collected.

Furthermore, according to a ninth disclosure, a facility operation support device that supports business of a user who operates a facility which provides a commodity or a service to a customer, is set to be configured to include an image storage that stores an area image of each area in the facility; a management server that manages the area image; and a delivery server that delivers a reading screen including the area image to a user terminal device, in which the delivery server generates the reading screen which includes a facility-based image list in which the area image of every facility relating to the area that is shared is shown side by side with a facility name, and an area selection menu for changing the area in the facility-based image list, and delivers the generated reading screen to the user terminal device.

Accordingly, the reading screen is delivered to the user terminal device and the facility-based image list that is included in the reading screen is available. Thus, the situation of the area can be simply compared with those of facilities, with the shared area being set to be a target. Furthermore, with the area selection menu, situations of different areas can be compared with those of a plurality of facilities by changing the area in the facility-based image list. Accordingly, even in a case where the number of facilities or the number of areas increases, a plurality of users can efficiently check the situation of the inside of the facility from anywhere, and can reasonably conduct the business for facility operation improvement.

Furthermore, according to a tenth disclosure, a configuration in which the delivery server displays a plurality of date and time input units in which input methods are different from each other on the reading screen and causes a user to input a display date and time of the area image in the facility-based image list using the plurality of date and time input boxes is set to be employed.

Accordingly, the operability when changing the display date and time of the area image can be increased.

Furthermore, according to an eleventh disclosure, a configuration in which the date and time unit uses at least two input methods, among a calendar input method that designates a date and time using a calendar, a date and time advancing and postponing input method that changes a date and time at a prescribed interval, a schedule input method that designates a date and time in a position in a time axis direction in a time scale, and a current date and time input method that performs a change to a current date and time is set to be employed.

Accordingly, the operability when changing the display date and time of the area image can be more increased.

Furthermore, according to a twelfth disclosure, a configuration in which, based on a user operation that selects the facility from the facility-based image list, the delivery server generates a reading screen that includes an area-based image list in which the area image in the same facility is shown side by side with the area name, and a facility selection menu for changing the facility in the area-based image list, and delivers the generated reading screen to the user terminal device is set to be employed.

Accordingly, with the area-based image list, a situation of each area can be checked, with a facility to which attention is given being set to be a target.

With the facility selection menu, by changing a facility in the area-based image list, situations of different facilities can be simply checked without returning to the reading screen for the facility-based image list.

Furthermore, according to a thirteenth disclosure, a configuration in which, based on a user operation that selects the area from the area-based image list, the delivery server generates a reading screen that includes a date-based image list in which the area images on each date during a prescribed duration relating to the selected area are shown side by side with each other, and an area selection menu for changing the area in the date-based image list, and delivers the generated reading screen to the user terminal device is set to be employed.

Accordingly, with the date-based image list, a situation on each date can be checked, with an area to which attention is given being set to be a target. With the area selection menu, by changing an area in the data-based image list, situations of different areas can be simply checked.

In this case, the duration may be set such that the user can designate the duration. Furthermore, if a duration is long, when area images on all day during the duration are displayed side by side with each other, the image are difficult to read. Because of this, an interval between each of dates shown in the date-based image list may be caused to be selected by the user and an area image on each date may be displayed in the interval. For example, when an interval of a week is set, area images on the same days during several weeks prior to a designated date may be displayed side by side with each other, and when an interval of a day is set, area images on several recent days prior to the designated day may be displayed side by side with each other.

Furthermore, according to a fourteenth disclosure, a configuration in which the area images at a point in time that is designated in advance are displayed side by side with each other on a per-date basis in the date-based image list is set to be employed.

Accordingly, by designating in advance a time span that is important the store operation, a situation during the important time span can be checked.

Furthermore, according to a fifteen disclosure, a configuration in which, based on a user operation that selects a date from the date-based image list, the delivery server generates a reading screen that includes a point-in-time-based image list in which the area images at each point in time on the selected date is shown side by side with each other in a time sequence, and an area selection menu for changing the area in the point-in-time-based image list, and delivers the generated reading screen to the user terminal device is set to be employed.

Accordingly, with the point-in-time-based image list, a situation of the area at each point in time can be checked, with a point in time to which attention is given being set to be a target. With the area selection menu, by changing an area in the point-in-time-based image list, situations of different areas can be simply checked.

Furthermore, according to a sixteenth disclosure, a configuration in which, based on the user operation that selects a high-quality image mode, the delivery server generates the reading screen that includes the area image of high resolution and delivers the generated reading screen to the user terminal device is set to be employed.

Accordingly, in the user terminal device, in a case where the user performs an operation of displaying a screen in an enlarged manner, the area image can be displayed in an enlarged manner without decreasing image quality. Accordingly, a situation of an area can be observed in detail and simply.

Furthermore, according to a seventeenth disclosure, a configuration in which the image storage acquires the reading still image that results from removing the moving object from the image which results from image-capturing the inside of the facility, periodically at a prescribed timing from the facility imaging device, generates the area image from the reading still image and stores the generated area image, and in which the delivery server delivers the area image at a point in time that is designated by the user to user terminal device is set to be employed.

Accordingly, because the moving object such as the person is removed from the area image, the privacy can be protected. Furthermore, among the reading still images that are sequentially generated in the facility imaging device, only the reading still image at a prescribed timing is transmitted. Because of this, the load of traffic on the network can be reduced compared with a case where the captured images (moving images) that temporally follow one another are transmitted, or where the reading still images that are sequentially generated are all transmitted. Accordingly, in the facility operation support device, the area image that is privacy-protected can be collected.

Furthermore, according to an eighteenth disclosure, a user terminal device that displays a screen based on information which is delivered from a facility operation support device that supports business of a user who operates a facility that provides a commodity or a service to a customer is set to be configured to display a reading screen that includes a facility-based image list in which an area image of every facility relating to an area that is shared is shown side by side with a facility name and an area selection menu for changing the area in the facility-based image list.

Accordingly, in the same as in the ninth disclosure, even in the case where the number of stores or the number of sales rooms increases, a plurality of users, such as the supervisors or the owners that have many stores, can efficiently check the situation of the inside of the store from anywhere, and can reasonably conduct the business of improving the store operation.

Furthermore, according to a nineteenth disclosure, a facility operation support method that supports business of a user who operates a facility which provides a commodity or a service to a customer, using an information processing device, is set to have a configuration in which the information processing device stores an area image of each area in the facility, generates a reading screen which includes a facility-based image list in which an area image of every facility relating to the area that is shared is shown side by side with a facility name, and an area selection menu for changing the area in the facility-based image list, and delivers the generated reading screen to a user terminal device.

Accordingly, in the same as in the ninth disclosure, even in the case where the number of stores or the number of sales rooms increases, the plurality of users, such as the supervisors or the owners that have many stores, can efficiently check the situation of the inside of the store from anywhere, and can reasonably conduct the business of improving the store operation.

An embodiment will be described below with reference to the drawings.

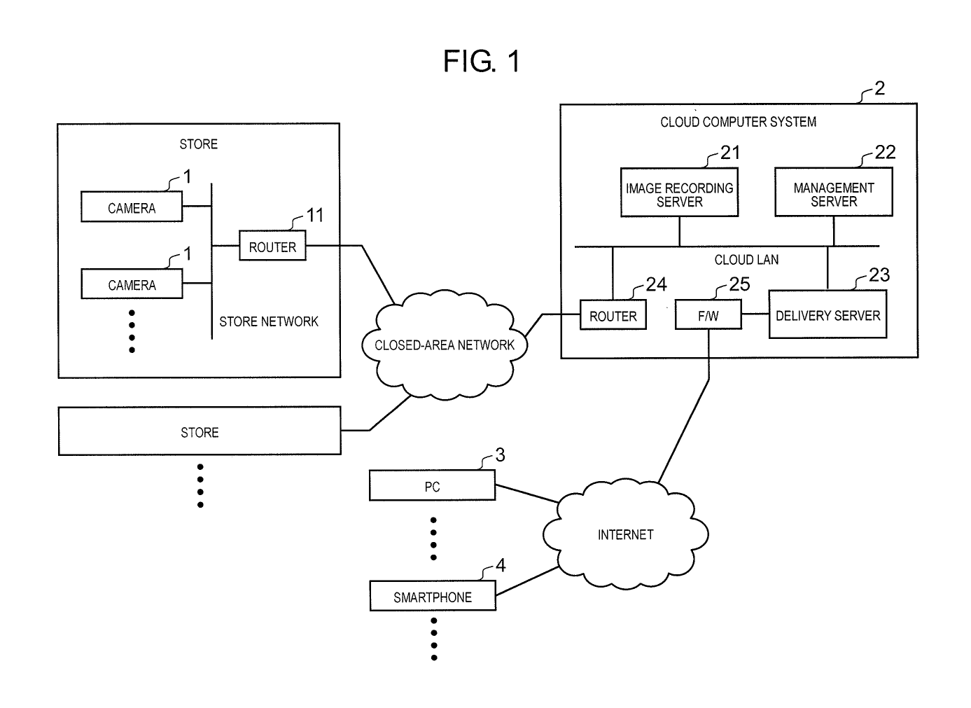

FIG. 1 is a diagram of an entire configuration of a facility operation support system according to the present embodiment.

The facility operation support system is set up with a retail chain store such as a convenience store being set to be a target, and includes camera (a facility imaging device) 1 that is provided on each of the plurality of stores (facilities), cloud computing system 2, and PC (a user terminal device) 3, and smartphone 4 (a user terminal device).

Camera 1 is installed at a suitable place within a store and image-captures the inside of the store. Camera 1 is connected to a closed-area network such as a Virtual Local Area Network (VLAN) through a network within the store and router 11.

Cloud computing system 2 includes image recording server (a facility image collecting device, an information storage, or an image processing device) 21, management server (an information processing device) 22, and delivery server (or an information processing device) 23. Image recording server 21, management server 22, and delivery server 23 are connected to each other through a cloud LAN. The cloud LAN is connected to the closes-area network through router 24. Delivery server 23 is connected to the Internet through firewall 25.

Image recording server 21 acquires an image that results from image-capturing the inside of the store from camera 1 and stores the acquired image. In the present embodiment, a sales room image of every sales room (every area) is extracted from a reading still image which is acquired from camera 1, and the extracted sales room image is stored. With a database, management server 22 manages the sales room image, information relating to a user or the store, information relating to a report or a topic that is input by the user, and the like. Delivery server (a Web server) 23 generates and delivers a screen that is read by the user in PC 3 and smart phone 4, and acquires information that is input by the user on the screen.

PC 3 and smartphone 4 can be operated by the user, such as a supervisor, a store owner, or a store manager, and the screen that is delivered from the delivery server 23 can be read using a Web browser.

In this type of facility operation support system, because camera 1 and image recording server 21 are connected to each other through the closed-area network, communication security can be ensured. Furthermore, because delivery server 23, and PC 3 and smartphone 4 are connected to each other through the Internet, delivery server 23 is accessed from PC 3 or smartphone 4 from anywhere.

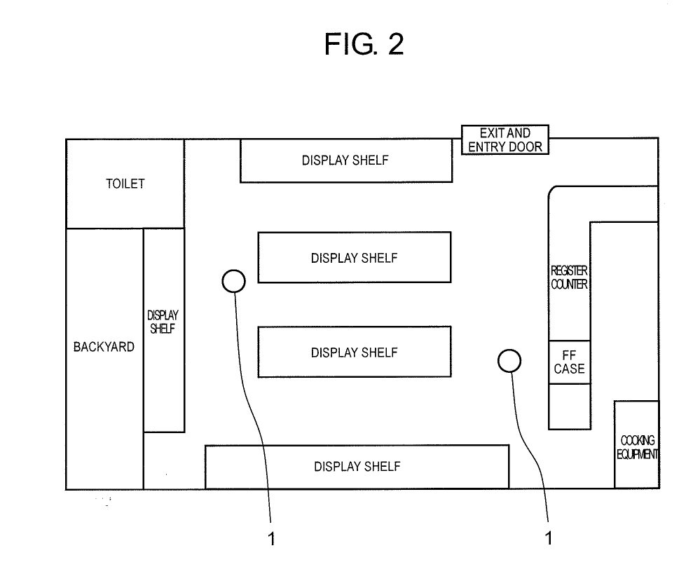

Next, a layout of the store and an installation situation of camera 1 will be described. FIG. 2 is a plan-view diagram of the store for describing the layout of the store and the installation situation of camera 1.

In the store, an entrance door, display shelves, a register counter, cooking equipment, and the like are installed. The display shelves are divided according to types of commodities, such as a fast food (FF), a cooked rice (a commodity, such as a rice ball, a packed lunch, or a sushi), a bakery, a desert, a processed food, miscellaneous goods, a perishable food, a magazine, and a newspaper. The cooking equipment is one for cooking the fast food such as a deep-fired chicken within the store, a display shelf (FF case) for the fast food is installed adjacent to the register counter. A customer enters the store through the entrance door, and moves along a passage between the display shelves within the store. When the customer finds a commodity that he/she wants to purchase, he/she picks it up and moves to a register counter. After making payment on account (paying for the commodity) at the register counter, the customer leaves the store through the entrance door.

Furthermore, in the store, a plurality of cameras 1 that image-captures the inside of the store are installed. Camera 1 is installed in a suitable position on the ceiling of the store. Particularly, in an example that is illustrated in FIG. 2, as camera 1, an omnidirectional camera with a fish-eye lens that has a photographing range of 360 degrees is employed, and with camera 1, commodities or the like that are displayed on the display shelves can be image-captured.

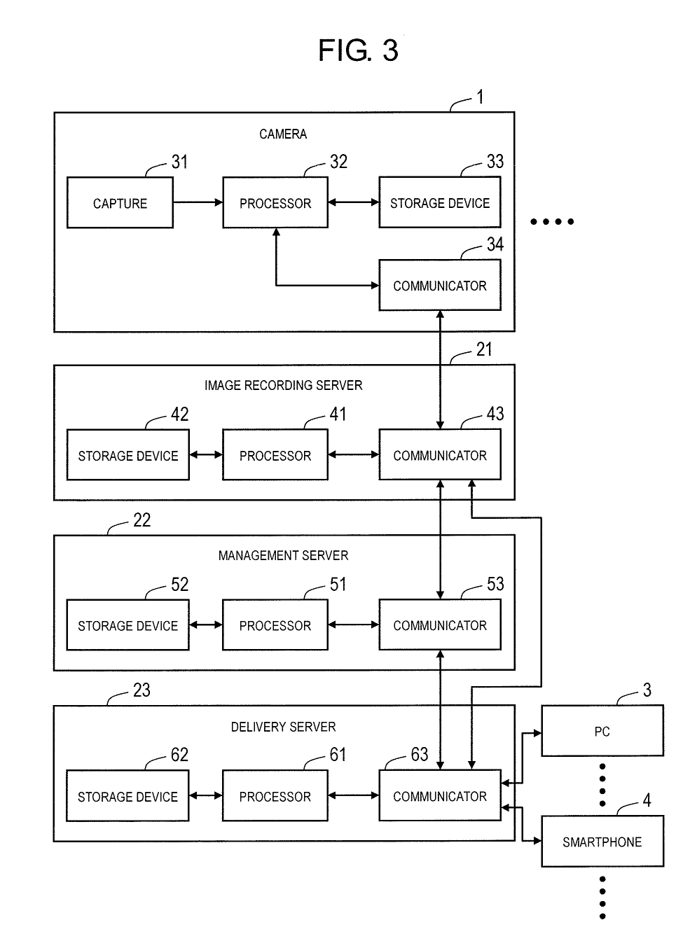

Next, schematic configuration of camera 1, image recording server 21, management server 22, and delivery server 23 that are illustrated in FIG. 1 will be described. FIG. 3 is a block diagram illustrating schematic configurations of camera 1, image recording server 21, management server 22, and delivery server 23.

Camera 1 includes capture 31, processor 32, storage device 33, and communicator 34.

Capture 31 includes an image sensor, and sequentially outputs captured images (frames), so-called a moving image, that temporally follow one another. Processor 32 performs image processing on the captured image, generates processed image and outputs the processed image. Storage device 33 stores a program that is executed in processor 32 or the captured image that is output from capture 31. Communicator 34 transmits the processed image that is output from processor 32, to image recording server 21 through a network.

In the present embodiment, in processor 32, whenever the captured image is input from capture 31, dominant image information is updated and the reading still image (a background image) that results from removing a moving object is generated as the processed image.

In the generation of the reading still image, a well-known background image generation technology can be used. For example, when the captured images that temporally follow one another are sequentially input, for a recent prescribed sampling duration (for example, five minutes), the brightness of each pixel in the captured image that is equivalent to 30 frames is collected, a brightness histogram that is approximated to a normal distribution is generated on a per-pixel basis, and color information in a prescribed range (±3σ) in the brightness histogram is stored. Thus, the background image can be generated by obtaining the dominant image information on a per-pixel basis, and this is possibly used as the reading still image.

The sampling duration may be such that the user can suitably set the sampling duration to be a suitable sampling duration for which a person is not copied.

In this type of background image generation processing, a color that has the highest brightness is selected from among a plurality of captured images for a past prescribed duration (for example, five minutes), and at this time, a color of a pixel changes in an image area of the moving object. However, as a result, a background color that has a high dominance rate is selected and the reading still image (the background image) that results from the moving object can be obtained. Furthermore, in a case where the moving object is a person, because there is a motion although small, a person-like image is displayed in a fussy state. Because of this, the privacy can be protected.

Furthermore, in the present embodiment, image recording server 21, image transmission request is made to camera 1 periodically at a prescribed timing (for example, at an interval of 15 minutes), and in communicator 34 of camera 1, the reading still image at that point in time is transmitted in response to the image transmission request from image recording server 21. At this point, in a case where the reading still image is transmitted from communicator 34 to image recording server 21, the transmission may be performed with a mobile router (not illustrated) or the like being involved. Furthermore, the reading still image is updated in processor 32 at any time when the captured images that temporally follow one another are input, and the reading still image that is updated at any time is transmitted at a prescribed timing.

Image recording server 21 includes processor 41, storage device 42, and communicator 43.

Communicator 43 transmits and receives required information to and from camera 1, management server 22, or delivery server 23. For example, the image transmission request is transmitted periodically at a prescribed timing (for example, at an interval of 15 minutes) to camera 1, and the reading still image that is transmitted from each camera 1 is received in response to the image transmission request. In the storage device 42, the reading still image from every camera 1, which is received in communicator 43, or a program that is to be executed in processor 41 is stored.

Processor 41 performs the image processing on the reading still image (an omnidirectional image) that is acquired from camera 1. In the image processing, the reading still image that is the omnidirectional image is equally divided into sales room images of the stores (for example, division of the image by 4). That is, the sales room image of each sales room is cut off (extracted) from the captured image. Furthermore, in processor 41, a thumbnail image that results from reducing an original image of the sales room image is generated. The sales room image (the original image and the thumbnail image) is stored in the storage device 42. Furthermore, processor 41 controls a timing at which the reading still image is acquired from camera 1.

At this point, the example in which processor 41 performs division processing of the sales room image, but processor 32 of camera 1 may transmit the sales room image of each sales room in a state of being extracted to image recording server 21, and may be stored in storage device 42.

In communicator 43, under the control of processor 41, when the acquisition of the reading still image from camera 1 at a prescribed image acquisition timing fails, the acquisition of the reading still image is retried repeatedly for a duration up to the image acquisition timing until the acquisition of the reading still image succeeds. Accordingly, a slight time difference occurs, but the reading still image at every prescribed time can be acquired without being leaked.

Management server 22 includes processor 51, storage device 52, and communicator 53.

Processor 51 performs processing that manages information (a file name, a retention bus, or the like) relating to the sales room image, information relating to the user or the store, information relating to a report or a topic that is input by the user, and the like, using a database. Storage device 52 stores information relating to the database or a program that is performed in processor 51. Communicator 53 transmits and receives required information to and from image recording server 21 or delivery server 23. For example, the information relating to the sales room image that is stored in image recording server 21 is received from image recording server 21, and information relating to the report or the topic that is input by the user is received from delivery server 23.

Delivery server 23 includes processor 61, storage device 62, and communicator 63.

Processor 61 performs processing that generates a screen that is read by the user in PC 3 or smartphone 4. Storage device 62 stores a program that is executed in processor 51. Communicator 63 transmits and receives required information to and from image recording server 21 or management server 22. For example, screen information that is generated in processor 61 is delivered to PC 3 or smartphone 4, and information that is input by the user is received in PC 3 or smartphone 4.

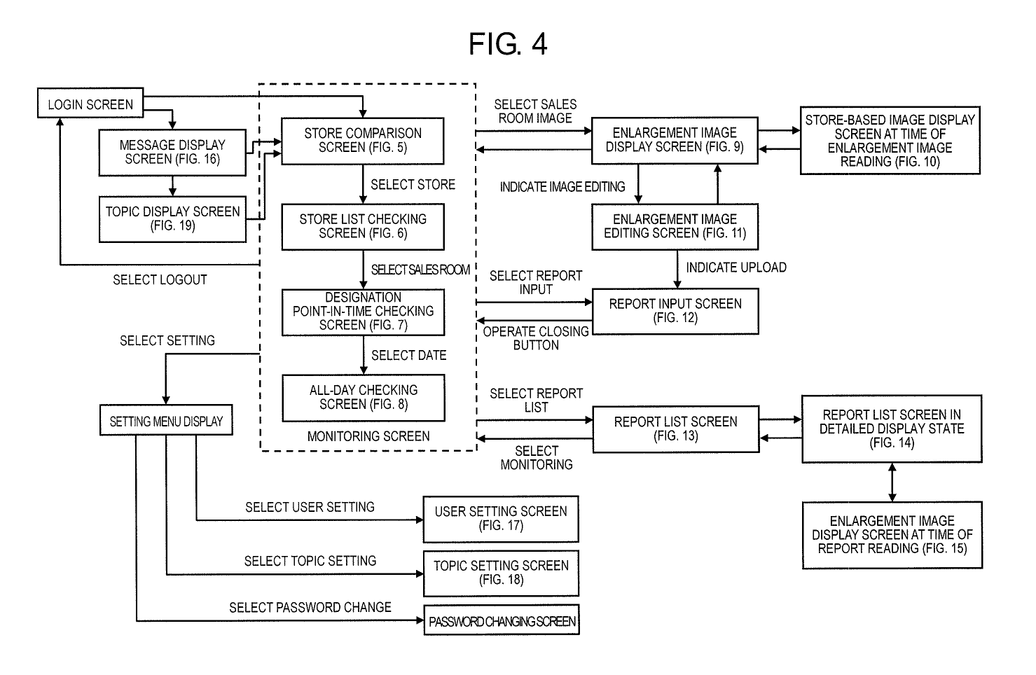

Next, a screen that is generated in delivery server 23 and is displayed on PC 3 will be described below. FIG. 4 is a descriptive diagram illustrating a transition situation of the screen that is generated in delivery server 23 and is displayed on PC 3.

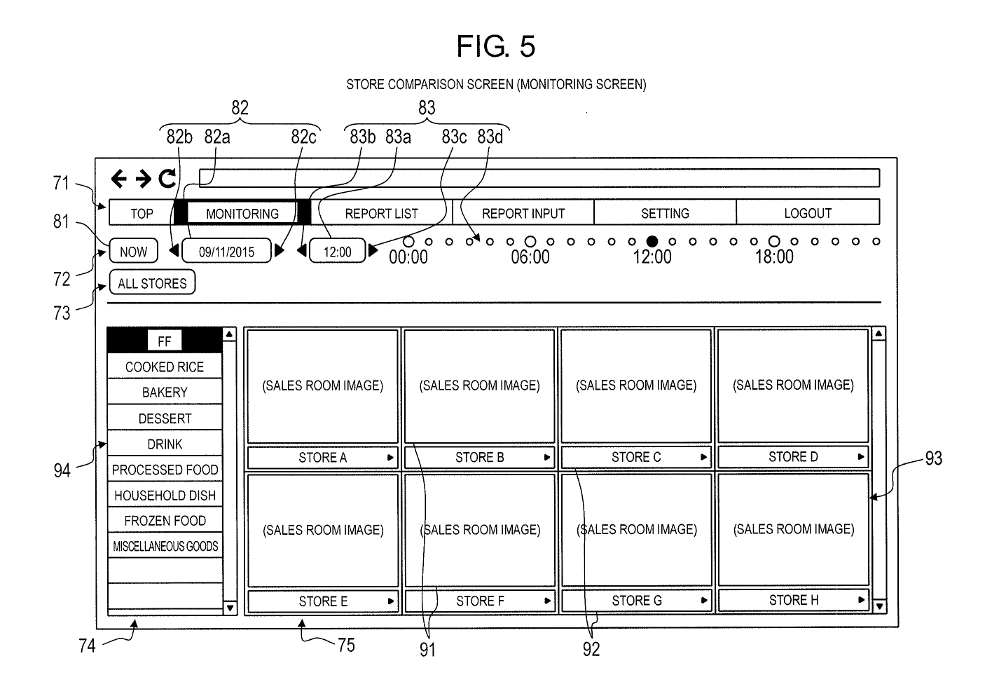

In PC 3, when a Web browser is activated and delivery server 23 is accessed, first, a login screen is displayed. In the present embodiment, use authentication is performed using a user ID and a password. When the user ID and the password are input in the login screen and the user authentication succeeds, a store comparison screen (refer to FIG. 5) is displayed as a top screen.

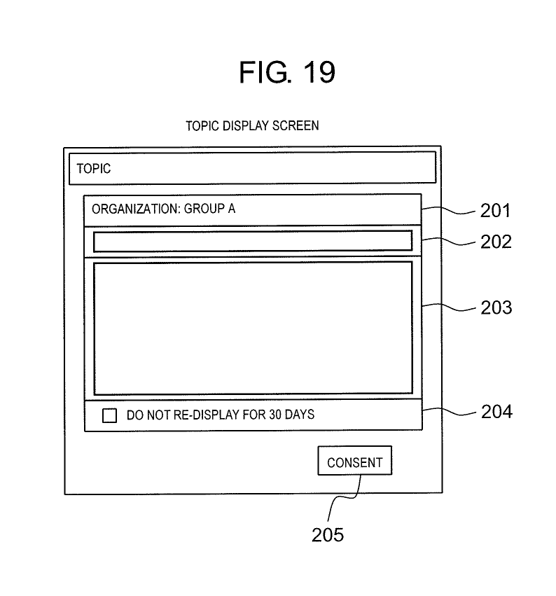

At this time, in a case where a report that is newly input by another user is present, but is not read, or in a case where a validity date of the password expires, a message display screen (refer to FIG. 16) on which a message to that effect is displayed is displayed. Furthermore, the topic that is input by the manager is present, a topic display screen (refer to FIG. 19) is displayed.

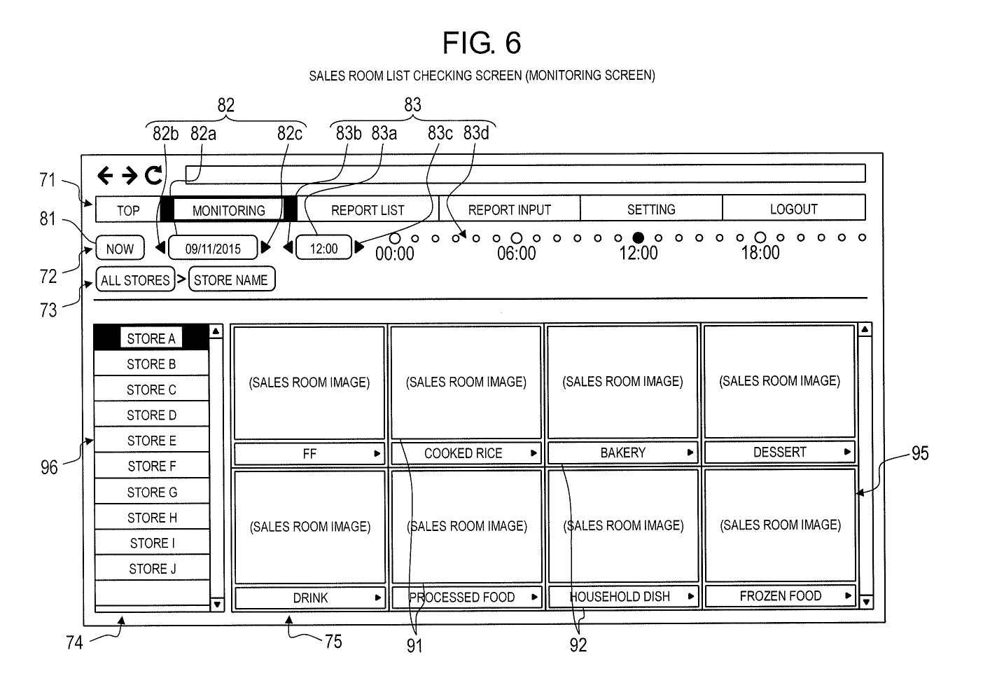

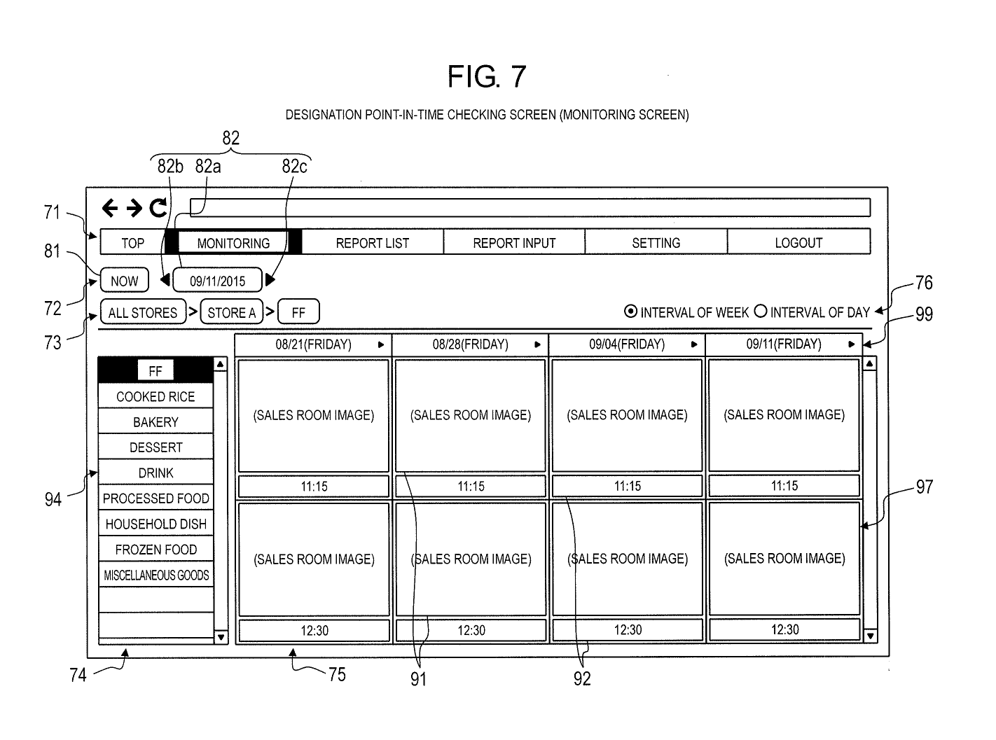

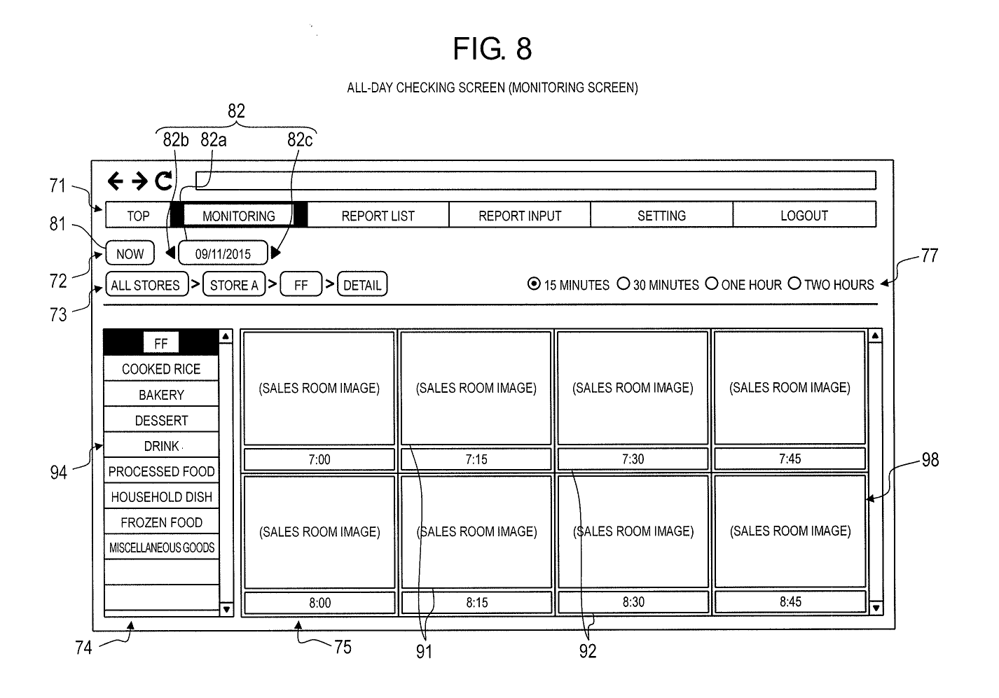

On the store comparison screen (refer to FIG. 5), a situation of the sales room can be compared with those of stores with a shared sales room being set to be a target. When any store is selected on the store comparison screen, transitioning to a sales room list checking screen (refer to FIG. 6) takes place. On the sales room list checking screen, a situation of each sales room in the selected store can be checked. When a sales room is selected on the sales room list checking screen, transitioning to a designation point-in-time checking screen (refer to FIG. 7) takes place. On the designation point-in-time checking screen, the situation of the sales room can be compared with those at different dates, with the selected sales room being set to be a target. When a date is selected on the designation point-in-time checking screen, transitioning to an all-day checking screen (refer to FIG. 8) takes place. On the all-day checking screen, the situation of the sales room at each point throughout the day on the selected date can be checked.

A plurality of sales room images that are extracted based on a display condition for each screen can be displayed on the store comparison screen, the sales room list screen, the designation point-in-time screen, and the all-day checking screen, and the situation of the sales room can be checked using the sales room image. The store comparison screen, the sales room list screen, the designation point-in-time screen, and the all-day checking screen are collectively referred to as a monitoring screen.

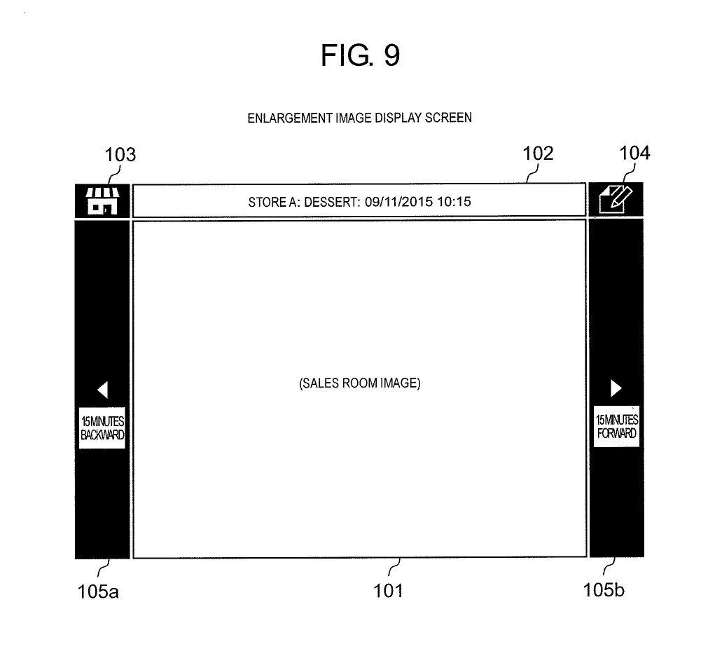

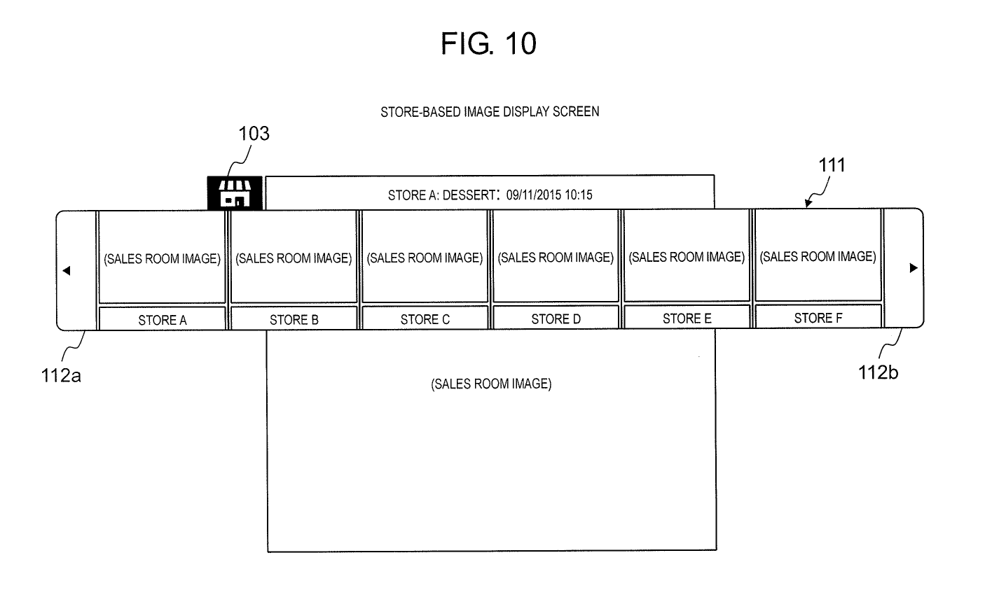

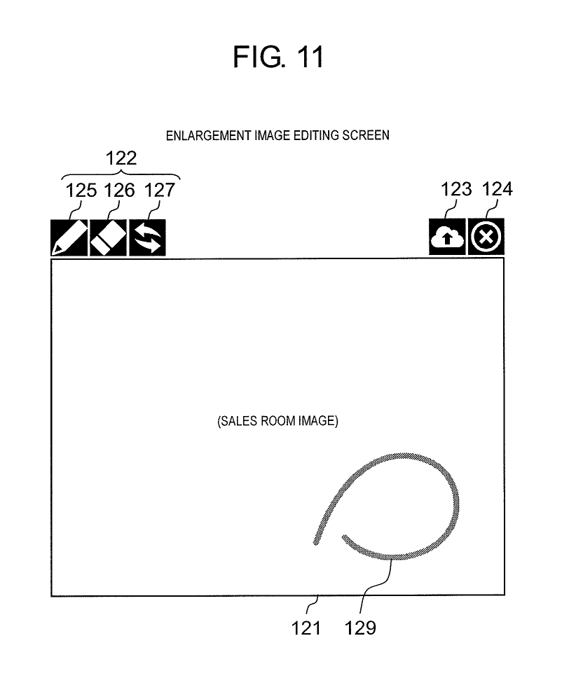

When the sales room image is selected on the monitoring screen, an enlargement image display screen (refer to FIG. 9) is displayed in a pop-up manner. A high resolution sales room image can be displayed in an enlarged manner on the enlargement image display screen, and the situation of the sales room can be checked in detail. When a sales room list is specified on the enlargement image display screen, transitioning to a store-based image display screen (refer to FIG. 10) takes place. On the store-based image display screen, sales room images of stores can be displayed side by side, and the sales room image that is to be displayed on the enlargement image display screen can be changed to that of another store. When image editing is specified on the enlargement image display screen, transitioning to an enlargement image editing screen (refer to FIG. 11) takes place. On the enlargement image editing screen, drawing can be performed by handwriting input on the sales room image.

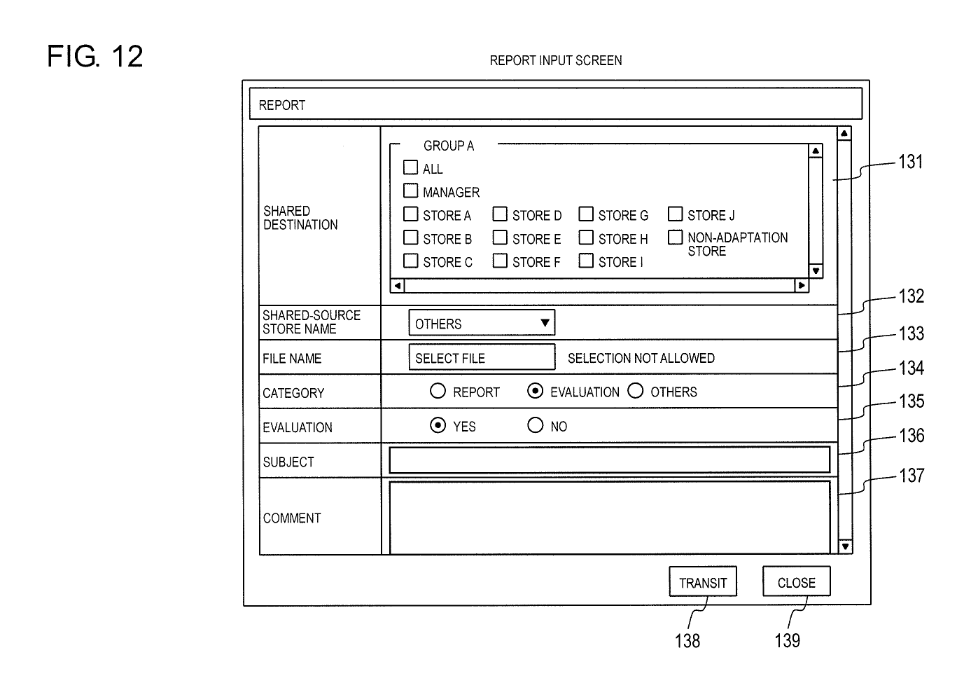

When an upload is specified on the enlargement image editing screen, transitioning to a report input screen (refer to FIG. 12) takes place. On the report input screen, input of each item relating to the report can be performed. Furthermore, with selection of report input from a main menu on the monitoring screen, transitioning to the report input screen can also take place.

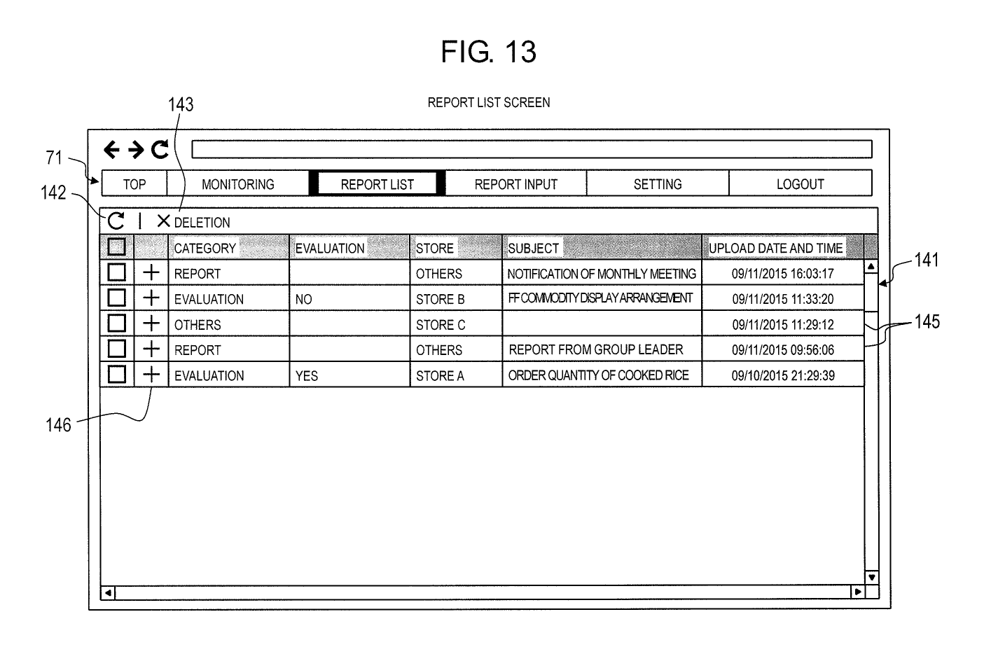

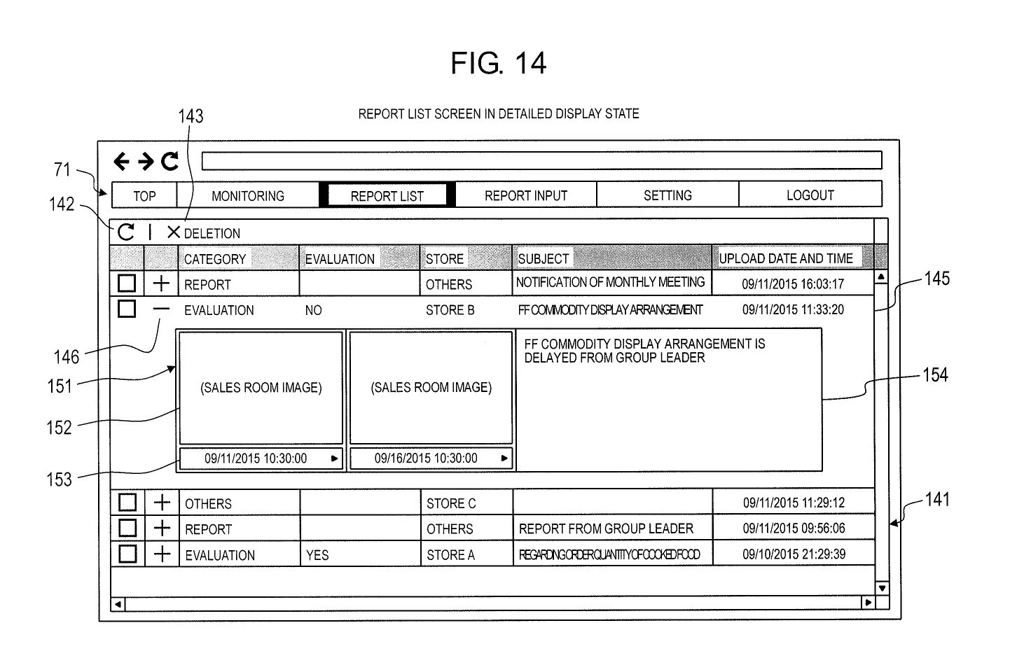

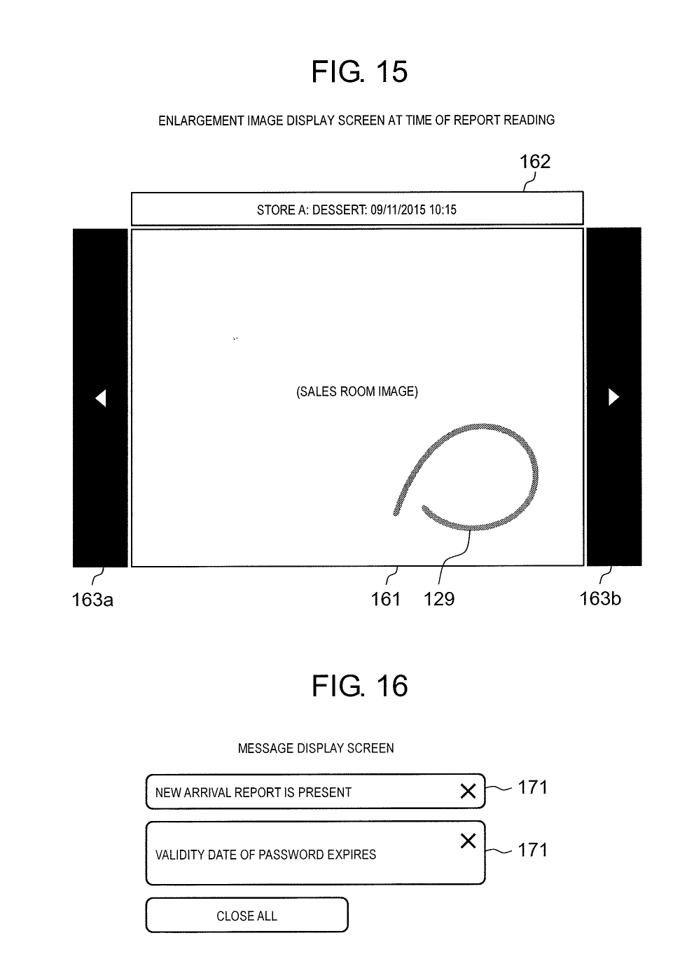

Furthermore, when a report list is selected from the main menu on the monitoring screen, transitioning to a report list screen (refer to FIG. 13) takes place. On the report list screen, a report is list-displayed with the user who logs in being designated as a shared destination. When a report is selected on the report list screen, transitioning to the report list screen (refer to FIG. 14) in a detailed display state takes place. On the report list screen in the detailed display state, a sales room image or a message that accompanies the report can be read. When a sales room image is selected on the report list screen in the detailed display state, the enlargement image display screen (refer to FIG. 15) is displayed on a pop-up manner. On the enlargement image display screen, the high resolution sales room image is displayed in an enlarged manner.

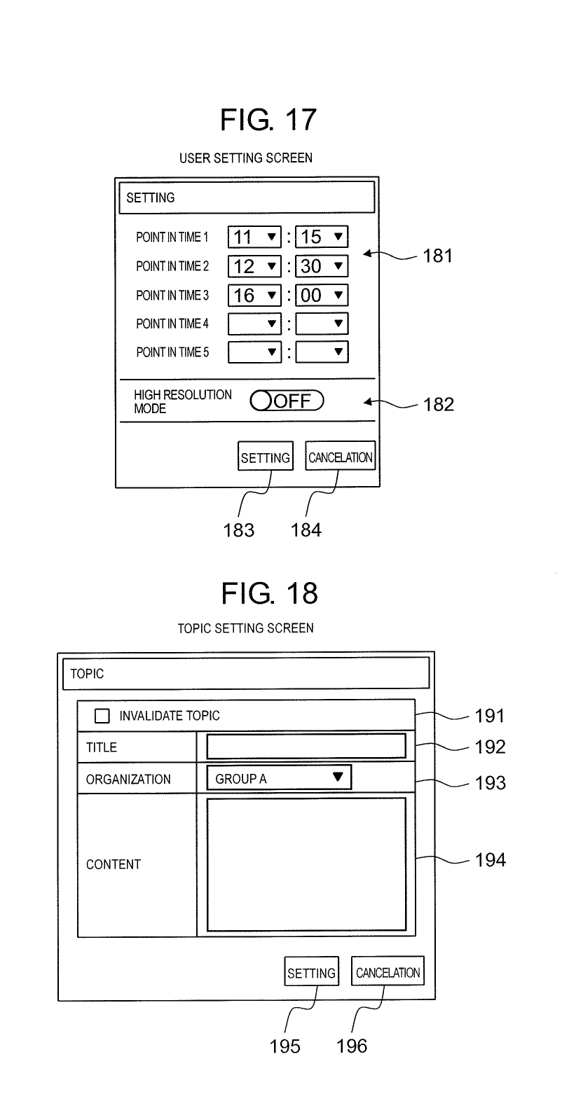

Furthermore, when a setting is selected from the main menu on the monitoring screen, a sub-menu is displayed. When a user setting, a topic setting, and a password change is selected from the sub-menu, a user setting screen (refer to FIG. 17), a topic setting screen (refer to FIG. 18), and a password changing screen (not illustrated), respectively, are displayed in a pop-up manner.

Next, the store comparison screen in the transition situation of the screen that is illustrated in FIG. 4 will be described. FIG. 5 is a descriptive diagram illustrating the store comparison screen.

Provided on the store comparison screen are main menu 71, date and time input unit 72, site map display unit 73, selection menu display unit 74, and image list display unit 75.

On main menu 71, any one of top, monitoring, report list, report input, setting, and logout can be selected (by clicking or tapping).

When the top is selected from main menu 71, transitioning to a top screen takes place. In the present embodiment, the store comparison screen is set to be the top screen. If the monitoring screen that is currently opened is other than the store comparison screen, that is, the sales room list checking screen, the designation point-in-time checking screen, or the all-day checking screen, transitioning to the store comparison screen takes place. At this time, a display date and time returns to a current point in time, precisely, a recent point in time (an image acquisition point in time) that is an image acquisition timing.

When the monitoring is selected from main menu 71, transitioning to the store comparison screen that is a top screen of the monitoring screen takes place. At this time, the display date and time returns to the current point in time (the recent image acquisition point in time).

When the report list is selected from main menu 71, transitioning to the report list screen (refer to FIG. 13) takes place.

When the repot input is selected from main menu 71, the report input screen (refer to FIG. 12) is displayed in a pop-up manner.

When the setting is selected from main menu 71, a sub-menu is displayed. On the sub-menu, any one of the user setting, the topic setting, and the password change can be selected. When the user setting is selected from the sub-menu, the user setting screen (refer to FIG. 17) is displayed in a pop-up manner. When the topic is selected from the sub-menu, the topic setting screen (refer to FIG. 18) is displayed in a pop-up manner. The topic setting screen is displayed only in the case of the manager. When the password change is selected from the sub-menu, the password changing screen (not illustrated) is displayed in a pop-up manner.

When the logout is selected from main menu 71, the monitoring screen is closed and the login screen is displayed.

Provided on date and time input unit 72 are NOW button 81, date changing unit 82, and point-in-time changing unit 83.

NOW button 81 is one for changing the display date and time of the sales room image on image list display unit 75 to the current point in time (the recent image acquisition point in time). When the NOW button is operated, the sales room image on the current date and time is displayed. Accordingly, in a case where a past situation was checked, but a current situation is desired to be checked, a current sales room image can be displayed.

The date changing unit 82 is one that changes the display day for the sales room image on image list display unit 75, and the sales room image on the selected date is displayed on image list display unit 75. Provided on the date changing unit 82 are date display unit 82a and arrow buttons 82b and 82c in the leftward and rightward directions.

A date that is currently being set is displayed on date display unit 82a. When date display unit 82a is operated, a calendar screen (not illustrated) can be displayed and the data can be selected on the calendar screen. Arrow buttons 82b and 82c are ones for advancing and postponing a date. When arrow button 82b in the leftward direction is operated, the display date and time is changed to a display date and time that is one day earlier. When arrow button 82c is the rightward direction is operated, the display date and time is a display date and time that is one day later.

Point-in-time changing unit 83 is one that changes a display point in time of the sales room image on image list display unit 75, and the sales room image at the selected point in time is displayed on image list display unit 75. Provided on point-in-time changing unit 83 are point-in-time display unit 83a, arrow buttons 83b and 83c in the leftward and rightward directions, and timer bar 83d.

A point in time that is currently being set is displayed on point-in-time display unit 83a. Arrow buttons 83b and 83c are ones for advancing and postponing a point in time that corresponds to a timing (for example, an interval of 15 minutes) for the image acquisition. When arrow button 83b in the leftward direction is operated, the display point in time is changed to a point in time (for example, 15 minutes earlier) that is one timing earlier. When arrow button 83c in the rightward direction is operated, the display point in time is changed to a point in time (for example, 15 minutes later) that is one timing later.

Timer bar 83d is one for selecting a time span within business hours (24 hours in the case of all-day business). A plurality of points that represents each time span are displayed side by side in the time axis direction. By selecting a button, changing to a point in time that is represented by the event takes place. A point for the selected time span changes in display color. Timer bar 83d is not displayed on the designation point-in-time checking screen (refer to FIG. 7) or the all-day checking screen (refer to FIG. 8).

Site map display unit 73 is one that displays the transition situation of the screen. Buttons for “all stores”, “store name”, “sales room name”, and “details” are displayed on site map display unit 73 according the morning screen (refer to FIGS. 5 to 8).

When each button is operated, transitioning to the corresponding monitoring screen takes place. That is, when the button for “all stores” is operated, transitioning to the store comparison screen (refer to FIG. 5) takes place. When the button for “store name” is operated, transitioning to the sales room checking screen (refer to FIG. 6) takes place. When the button for “sales room name” is operated, transitioning to the designation point-in-time checking screen (refer to FIG. 7) takes place. When the button for “details” is operated, transitioning to the all-day checking screen (refer to FIG. 8) takes place. A store name that is currently selected is displayed on the button for “store name”, and a sales room name that is currently selected is displayed on the button for “sales room name”.

Provided on image list display unit 75 are a plurality of sales room image display units 91 that are arranged side by side vertically and horizontally, and description display unit 92 that is positioned under sales room image display unit 91. Displayed on sales room image display unit 91 is the sales room image (a low resolution thumbnail image or a high resolution original-image).

Furthermore, in examples that are illustrated in FIGS. 5 to 8, four sales room images are displayed side by side in the horizontal direction. The number of sales room images that are arranged in the vertical direction is random, and in a case where the sales room images do not fit into one screen, scrolling may be performed using a scrolling bar.

Particularly, on the store comparison screen that is illustrated in FIG. 5, store-based image list 93 in which a sales room image of every store relating to a shared sales room is shown side by side with a store name is displayed on image list display unit 75. A sales room image of each store is displayed on sales room image display unit 91, and the store name is displayed on description display unit 92.

Furthermore, sales room images of all stores associated with to a group to which the user belongs to are shown in store-based image list 93. Furthermore, in an initial state immediately after the login, the sales room image on the current date and time is displayed. At this time, a store of which the user is directly in charge is preferentially displayed. The sales room images are arranged side by side in the direction from the left end (upper left) toward the right end in the highest row, next in the direction from the left end to the right end in the second highest row, and so forth.

With store-based image list 93, the situation of the sales room can be compared with those of the stores with the shared sales room being set to be a target.

Furthermore, on the store comparison screen that is illustrated in FIG. 5, sales room selection menu 94 is displayed on selection menu display unit 74. All sales rooms associated with the group to which the user belongs are displayed on sales room selection menu 94. When a sales room is selected from the sales room selection menu, the sales room image in store-based image list 93 is changed to that of the selected sales room.

With sales room selection menu 94, a sales room in the store-based image list 93 is changed, and thus situations of different sales rooms can be compared with those of a plurality of stores. Accordingly, a store to which attention has to be given regarding various sales rooms can be simply found out.

On image list display unit 75 on the store comparison screen, when a sales image in the store-based image list 93 is selected for operation, the enlargement image display screen (refer to FIG. 9) relating to the selected sales room is displayed in a pop-up manner. Furthermore, when a store name in store-based image list 93 is selected, transitioning to the sales room list checking screen (refer to FIG. 6) relating to the selected store takes place.

Main menu 71 and date and time input unit 72 are common to other monitoring screens (the sales room list checking screen, the designation point in time checking screen, and the all-day checking screen) that will be described below.

Next, the sales room list checking screen in the transition situation of the screen that is illustrated in FIG. 4 will be described. FIG. 6 is a descriptive diagram illustrating the sales room list checking screen.

When a store name in store-based image list 93 that is displayed on image list display unit 75 on the store comparison screen (refer to FIG. 5) is selected, the sales room list checking screen that is illustrated in FIG. 6 is displayed.

On the sales room list checking screen that is illustrated in FIG. 6, sales room-based image list 95 in which sales room images of all sales rooms in the store that is selected on the store comparison screen are shown side by side with a sales room name is displayed on image list display unit 75. A sales room image of each sales room is displayed on sales room image display unit 91, and a sales room name is displayed on description display unit 92.

With sales room-based image list 95, the situation of each sales room in the selected store can be checked on the store comparison screen (refer to FIG. 5).

Furthermore, on the sales room list checking screen that is illustrated in FIG. 6, store selection menu 96 is displayed on selection menu display unit 74. All stores associated with the group to which the user belongs are displayed on store selection menu 96. When a store is selected from store selection menu 96, a sales room image in sales room-based image list 95 is changed to that of the selected store.

With store selection menu 96, a sales room in a sales room-based image list 95 is changed, and thus situation of different sales rooms can be compared. Accordingly, a sales room to which attention has to be given regarding one store can be simply found out.

On image list display unit 75 on the sales room list checking screen, when a sales room image in sales room-based image list 95 is selected for operation, the enlargement image display screen (refer to FIG. 9) relating to the selected sales room is displayed on a pop-up manner. Furthermore, when a sales room name in sales room-based image list 95 is selected for operation, transitioning to the designation point-in-time checking screen (refer to FIG. 7) relating to the selected sales room takes place.

Next, the designation point-in-time checking screen in the transition situation of the screen that is illustrated in FIG. 4 will be described. FIG. 7 is a descriptive diagram illustrating the designation point-in-time checking screen.

When a sales room name in the sales room list is selected for operation, on image list display unit 75 on the sales room list checking screen (refer to FIG. 6), the designation point-in-time checking screen that is illustrated in FIG. 7 is displayed.

On the designation point-in-time checking screen, date-based image list 97 in which sales room images in each item within a prescribed duration, which relate to the sales room that is selected on the sales room list checking screen are shown side by side is displayed on image list display unit 75. A sales room image of each sales room is displayed on sales room image display unit 91, and a point in time is displayed on description display unit 92. Furthermore, a date is displayed on date display unit 99 that is provided in the highest row.

Displayed on date-based image list 97 are a designated day inclusive and a sales room image at a prescribed display point in time on each of the prescribed number of days that are at a prescribed interval, starting from the designated date. In an example that is illustrated in FIG. 7, sales room images that correspond to four days that includes the designated day inclusive are displayed. Furthermore, sales room images at the same display point in time on each day are horizontally displayed side by side. The display point in time is set in advance on the user setting screen (refer to FIG. 5).

Furthermore, display interval selector 76 that selects an interval at which a date is displayed on date-based image list 97 on designation point-in-time checking screen. In the example that is illustrated in FIG. 7, any one of an interval of a week and an interval of a day can be selected. When the weekly basis is selected, sales room image on past days that are one week, two weeks, and three weeks, respectively, earlier than the designated day inclusive, that is, on days that are the same as designated days that are one week, two weeks, and the three weeks, respectively, earlier, are displayed. When the daily basis is selected, sales room images for the past three days retroactively from the designated day itself are displayed.

In the example that is illustrated in FIG. 7, the interval of a week is selected. The designated day is September 11 (Friday). Sales room images on September 4, August 28, and August 21 that are one week, two weeks, and three weeks, respectively, earlier are displayed. Furthermore, when the interval of a day is selected, a sales room image on September 11 (Friday) that is the designated day, sales room images on September 10 (Thursday), September 9 (Wednesday), and September 8 (Tuesday) that are one day, two days, and three days, respectively, earlier, are displayed.

With the date-based image list 97, situations of sales room on different days can be compared with each other.

Furthermore, in the same as on the store comparison screen (refer to FIG. 5), on the store comparison screen that is illustrated in FIG. 7, sales room selection menu 94 is displayed on selection menu display unit 74. When a sales room is selected from sales room selection menu 94, the sales room image in date-based image list 97 is changed to that of the selected sales room.

On image list display unit 75 on the designation point-in-time checking screen, when a sales room image in date-based image list 97 is operated for selection, the enlargement image display screen (refer to FIG. 9) relating to the selected sales room is displayed on a pop-up manner. When a date in the date-based image list 97 is selected for operation, transitioning to the all-day checking screen (refer to FIG. 8) relating to the selected date takes place.

Next, the all-day checking screen in the transition situation of the screen that is illustrated in FIG. 4 will be described. FIG. 8 is a descriptive diagram illustrating the all-day checking screen.

On the designation point-in-time checking screen (FIG. 7), when a date in the date-based image list 97 that is displayed on image list display unit 75 is selected, transitioning to the all-day checking screen that is illustrated in FIG. 8 takes place.

On the all-day checking screen, point-in-time-based image list 98 in which sales room images at points in time all day on the date that is selected on the designation point-in-time checking screen are shown side by side with each other in a time sequence is displayed on image list display unit 75. A sales room image of each sales room is displayed on sales room image display unit 91, and a point in time is displayed on description display unit 92.

Furthermore, display interval selector 77 that selects an interval at which a point in time is displayed on point-in-time-based image list 98 is provided on the all-day checking screen. In an example that is illustrated in FIG. 8, any one of 15 minutes, 30 minutes, one hour, and two hours can be selected. When 15 minutes, 30 minutes, one hour, and two hours are selected, a sales room image is displayed at intervals of 15 minutes, 30 minutes, one hour, and two hours, respectively.

With point-in-time-based image list 98, a situation of a sales room at a date to which attention is given can be checked during all time spans at the date.

Furthermore, in the same as on the store comparison screen (refer to FIG. 5), on the all-day checking screen that is illustrated in FIG. 8, sales room selection menu 94 is displayed on selection menu display unit 74. When a sales room is selected from sales room selection menu 94, the sales room image in point-in-time-based image list 98 is changed to that of the selected sales room.

On image list display unit 75 on the all-day checking screen, when a sales room image in point-in-time-based image list 98 is operated for selection, the enlargement image display screen (refer to FIG. 9) relating to the selected sales room is displayed on a pop-up manner.

In the present embodiment, while narrowing-down is performed in this order: stores, sales rooms, dates, using four monitoring screens sequentially, that is, the store comparison screen, the sales room list checking screen, the designation point-in-time checking screen, and the all-day checking screen, each screen is read. Thus, a situation of each sales room on each day in each sales room of each store can be efficiently checked. In the case of the user who is in charge of a plurality of facilities, such as a supervisor or an owner who manages many stores, first, it is desirable that a situation of each sales room is compared with those of a plurality of stores. For that reason, in the present embodiment, the store list comparison screen is first displayed immediately after the login.

Next, the enlargement image display screen in the transition situation of the screen that is illustrated in FIG. 4 will be described. FIG. 9 is a descriptive diagram illustrating the enlargement image display screen.

When a sales room image is selected for operation, on the monitoring screen (refer to FIGS. 5 to 8), the enlargement image display screen that is illustrated in FIG. 9 is displayed in a pop-up manner.

Provided on the enlargement image display screen are enlargement image display unit 101, description display unit 102, store button 103, editing button 104, and arrow buttons 105a and 105b in the leftward and rightward directions. An enlarged sales room image (a high resolution original-image) is displayed on enlargement image display unit 101. Displayed on description display unit 102 are a store name, a sales room name, and a date and time.

With the enlargement image display screen, a situation of a sales room of a store to which attention is given can be observed in detail.

When store button 103 is operated on the enlargement image display screen, the store-based image display screen (refer to FIG. 10) is displayed in a pop-up manner. When editing button 104 is operated, transitioning to the enlargement image editing screen (refer to FIG. 11) takes place. Arrow buttons 105a and 105b are ones for advancing and postponing changing a point in time that corresponds to a timing (for example, 15 minutes) for image acquisition. When arrow button 105a in the leftward direction is operated, the display point in time is changed to a point in time (for example, 15 minutes earlier) that is one timing earlier. When arrow button 105b in the rightward direction is operated, the display point in time is changed to a point in time (for example, 15 minutes later) that is one timing later.

Next, the store-based image display screen at the time of enlargement image reading in the transition situation of the screen that is illustrated in FIG. 4 will be described. FIG. 10 is a descriptive diagram illustrating the store-based image display screen at the time of the enlargement image reading.

When store button 103 is operated on the enlargement image display screen (refer to FIG. 9), the store-based image display screen that is illustrated in FIG. 10 is displayed in a pop-up manner.

Provided on the store-based image display screen are image list display unit 111, arrow buttons 112a and 112b in the leftward and rightward directions, and store button 103.

A sales room image of each store is displayed side by side with a store name on image list display unit 111. At this point, the sales room image that is displayed is one that relates to a sales room that is the same as on an enlargement image display screen that is a transition source in all stores associated with the group to which the user belongs.

Arrow buttons 112a and 112b are ones for displaying a sales room image of a store, which does not fit into image list display unit 111. When each of arrow buttons 112a and 112b in the leftward and rightward directions is operated, one sales room image that is displayed on image list display unit 111 moves in the leftward direction or in rightward direction, in such a manner that a sales room image of a store, which is not displayed, is displayed.

When the sales room image is selected for operation, on image list display unit 111, the store-based image display screen is closed and thus, returning to the enlargement image display screen (refer to FIG. 9) takes place, the enlarged sales room image of the selected store is displayed on the enlargement image display screen. Furthermore, when store button 103 is selected for operation, the store-based image display screen is closed and thus returning to the enlargement image display screen (refer to FIG. 9) takes place, and a sales room image of an original store is displayed on the enlargement image display screen.

Accordingly, because enlarged sales room images of different stores can be displayed without returning the store list comparison screen (refer to FIG. 5), a load that is imposed on the user operation can be greatly reduced.

Next, the enlargement image editing screen in the transition situation of the screen that is illustrated in FIG. 4 will be described. FIG. 11 is a descriptive diagram illustrating the enlargement image editing screen.

When editing button 104 is operated on the enlargement image display screen (refer to FIG. 9), transitioning to the enlargement image editing screen that is illustrated in FIG. 11 takes place.

Provided on the enlargement image editing screen are enlargement image display 121, handwriting tool selector 122, upload button 123, and closing button 124. In the same manner as on the enlargement image display screen (refer to FIG. 9), an enlarged room image (a high resolution original-image) is displayed on enlargement image display unit 121.

Provided on the handwriting tool selector 122 are pencil button 125, erasure rubber button 126, and initialization button 127. When pencil button 125 is selected, a line can be drawn on the enlarged sales room image on enlargement image display 121. At this time, a drawing color can be selected from among a plurality of colors (for example, red, blue, and yellow). When erasure rubber button 126 is selected, the drawn line can be erased. When initialization button 127 is selected, the drawn line can be erased and returning to a pre-editing state can take place.

With the enlargement image editing screen, drawing by hand can be performed on the enlarged sales room image. Accordingly, a portion of the enlarged sales room image, to which attention has to be given can be indicated with drawn image 129 that results from handwriting input.

When upload button 123 is operated, transitioning to the report input screen (refer to FIG. 12) takes place. Furthermore, when closing button 124 is operated, transitioning to the enlargement image display screen (refer to FIG. 9) takes place.

At this point, when upload button 123 is operated, drawing information that results from the handwriting input is uploaded to delivery server 23, and in management server 22, the drawing information, along with the sales room image, is registered in report management information.

In the present embodiment, the drawing by hand can be set to be performed on the enlarged sales room image, but marks (stamps) in various forms, which are prepared in advance, can be set to be drawn on the enlarged sales room image.

Next, the report input screen in the transition situation of the screen that is illustrated in FIG. 4 will be described. FIG. 12 is a descriptive diagram illustrating the report input screen.

When upload button 123 is operated on the enlargement image editing screen (refer to FIG. 11), transitioning to the report input screen that is illustrated in FIG. 12 takes place. Furthermore, when the report input is selected from main menu 71 on the monitoring screen (refer to FIGS. 5 to 8), the report input screen is displayed in a pop-up manner.

The report input screen is one into which the user (a report writer) input information relating to a report. Provided on the report input screen are shared destination selector 131, shared source selector 132, capture image selector 133, categorization selector 134, evaluation input unit 135, subject input unit 136, comment input unit 137, transmission button 138, and closing button 139.

Shared destination selector 131 is one through which the user selects a shared destination (a delivery destination) of the report. A store associated with the group to which the user belongs and a manager (a supervisor or the like) is displayed as shared destinations on shared destination selector 131, a check box is provided to each shared destination, and thus each shared destination can be individually selected. Furthermore, a check box for “all” is provided, and all stores and managers can be collectively selected.

Shared source selector 132 is one through which the user selects a store name (a name of a store that is a target for reporting) that is a shared source of the report. At this point, a case where transitioning from the enlargement image editing screen (refer to FIG. 11) takes place, a store name of the enlarged sales room image that is displayed on the enlargement image editing screen is automatically input by the shared source selector, and is reflected.

Capture image selector 133 is one through which the user selects a file of the captured image that is attached to the report, in a case where the report input is selected from main menu 71 and thus, transitioning to the report input screen takes place. In this case, a captured image that results for the user image-capturing a sales room using smartphone 4 may be transferred in advance to PC 3. At this point, the selected sales room image, along with input information, is uploaded to delivery server 23. In a case where transitioning from the enlargement image editing screen takes place, because the sales room image that is edited on the enlargement image editing screen is automatically set for an attachment image and is reflected, selection of the file does not need to be made.

In camera 1, an image on which protection of customer's privacy is performed by moving object removal processing is output, but the protection of customer's privacy cannot be performed on an image that is captured by the user using smartphone 4 or the like. For that reason, in PC 3, face detection processing is performed, and at this point, in a case where a face is detected, a warning that upload cannot be performed may be output. In this case, if, with an image editing application of smartphone 4 or PC 3, the user can set painting-out processing to be performed on an image area of a customer, the captured image can be uploaded. In PC 3, masking processing that covers an area of the detected face may be automatically performed.

Categorization selector 134 is one that selects a category of the report. At this point, any one of report (report other than evaluation), evaluation, and others can be selected.

Evaluation input unit 135 is one into which the user inputs a result of evaluation, and is displayed in a case where the evaluation is selected in categorization selector 134. At this point, any one of “YES” and “NO” that mean good and bad results, respectively, can be selected.

Subject input unit 136 is one into which a subject of the report is input.

Comment input unit 137 is one into which a comment (a message) that is notified to the user who is a shared destination is input. The user inputs information relating to evaluation on a store, report on a store, and other informative matters, information or the like relating to an action for improvement that is performed on a store, and information that has to be shared with other users, into comment input unit 137. For example, in a case where the category of the report is the evaluation, a comment that is to be made on the identification of and counseling on an improvement-needed matter is input.

When transmission button 138 is operated, input information relating to content that is input by the user on the report input screen, is uploaded from PC 3 to delivery server 23. In a case where the user selects the captured image in capture image selector 133, the captured image is also uploaded from PC 3 to delivery server 23.

The input information that is uploaded to delivery server 23 is registered in the report management information (a report list of group members) of management server 22. Furthermore, the captured image that is uploaded is stored in image recording server 21, and is registered in the report management information in management server 22. At this time, in management server 22, a sales room image that is displayed on the enlargement image display screen, a drawing information that results from the handwriting input, and a captured image that is selected by the user are managed in a state of being associated with the input information that is input through the report input screen.

When closing button 139 is operated, the report input screen is closed, and transitioning to the monitoring screen (refer to FIGS. 5 to 8) that is a transition source takes place.

Next, the transition situation in the transition situation of the screen that is illustrated in FIG. 4 will be described. FIG. 13 is a descriptive diagram illustrating the report list screen.

When the report list is selected from main menu 71 on the monitoring screen (refer to FIGS. 5 to 8), transitioning to the report list screen that is illustrated in FIG. 13 takes place.

The report list screen is one that displays in the form of a list an outline of the report which is designated as a shared destination by the user (a report reader) who logs in delivery server 23 in PC 3. Provided on the report list screen are report list display unit 141, update unit 142, and deletion unit 143.

Outline display box 145 for every report is provided on report list display unit 141. Displayed on outline display box 145 is information relating to each item, which is input on the report input screen (refer to FIG. 12), that is, information relating to each of the items for classification, evaluation, shared-source store (report-target store), subject, and date and time of upload.

On report list display unit 141, a report that is not read is empathetically displayed by changing a thickness or a display color of each of letters of in outline display box 145, in such a manner that the report which is not read can be easily determined along with an already-read report. Furthermore, in report list display unit 141, sorting (side-by-side arrangement) can be performed on each item.

Update unit 142 is one that updates a report which is displayed on report list display unit 141 to a recent state. Deletion unit 143 is one that deletes the report on report list display unit 141. In report list display unit 141, a check box is provided to each comment. When the check box is selected and the deletion unit 143 is operated, the selected report is deleted.

Furthermore, report list display unit 141, detail display button 146 is provided to each comment. When detail display button 146 is operated, transitioning to the report list screen (refer to FIG. 14) in the detailed display state.

Next, the report list screen in the detailed display state in the transition situation of the screen that is illustrated in FIG. 4 will be described. FIG. 14 is a descriptive diagram illustrating the report list screen in the detailed display state.

When detail display button 146 is operated on the report list screen (refer to FIG. 13), transitioning to the report list screen in the detailed display state that is illustrated in FIG. 14 takes place.

The report list screen in the detailed display state is one that displays the detailed content of the report, and outline display box 145 is displayed under selected detail display unit 151 on report list display unit 141.

Provided on detail display unit 151 are image display unit 152, image capture date and time display unit 153, and comment display unit 154. In the case of the report that is input on the report input screen (refer to FIG. 12) that transitions from the enlargement image editing screen (refer to FIG. 11), a sales room image that is attached to the report, and a sales room image at a recent point in time in a store and a sales room that are the same as those which relate to the attached image are displayed side by side on image display unit 152, and thus a change from a past sales room situation to a current sales room situation can be known. In the case of the report that is input on the report input screen that transitions from the monitoring screen (refer to FIGS. 5 to 8), only the selected captured image is displayed.

A date and time of capture of a sales room image is displayed on image capture date and time display unit 153. When image capture date and time display unit 153 is operated, transitioning to the store list comparison screen (refer to FIG. 5) relating to the date and time of the sales room image takes place.

When a sales room image on image display unit 152 is operated, the enlargement image display screen (refer to FIG. 15) at the time of report reading is displayed in a pop-up manner.

A comment that is input on the report input screen (refer to FIG. 12) is displayed on comment display unit 154.

When detail display button 146 for the comment, on which detail display unit 151 is displayed, is operated on the report list screen in the detailed display state, detail display unit 151 is closed, and returning to the report list screen (refer to FIG. 13) in a standard state takes place.

Next, the enlargement image display screen at the time of the report reading in the transition state of the screen that is illustrated in FIG. 4 will be described. FIG. 15 is a descriptive diagram illustrating the enlargement image display screen at the time of the report reading.

When a sales room image is selected on the report list screen (refer to FIG. 14) in the detailed display state, the enlargement image display screen that is illustrated in FIG. 15 is displayed in a pop-up manner.

Provided on the enlargement image display screen are enlargement image display unit 161, description display unit 162, and arrow buttons 163a and 163b in the leftward and rightward directions.

The enlarged sales room image is displayed on enlargement image display unit 161. A drawn image 129 that results from the handwriting input is also displayed on the sales room image. A store name, a sales room name, and a date and time are displayed on description display unit 162. Arrow buttons 163a and 163b are ones that perform switching between two sales room images that are displayed on detail display unit 151 on the report list screen (refer to FIG. 14) in the detailed display state. When the arrow button 163a in the leftward direction is operated, the sales room image that is attached to the report, and when the arrow button 163b is operated, a current sales room image is displayed.

Next, the message display image in the transition situation of the screen that is illustrated in FIG. 4 will be described. FIG. 16 is a descriptive diagram illustrating the message display screen.

The message display screen is displayed in a pop-up manner on the monitoring screen (the store list comparison screen in FIG. 5) immediately after the login. In a case where a report (a new-arrival report) that is not read is present on the message display screen, or a case where the validity date of the password expires, a message (alert) to that effect is displayed on message display unit (an alert box) 171. Accordingly, the user can know that the report which is not read is present or that the validity date of the password expires.

Next, the user setting screen in the transition situation of the screen that is illustrated in FIG. 4 will be described. FIG. 17 is a descriptive diagram illustrating the user setting screen.

The setting is selected from main menu 71 on the monitoring screen (refer to FIGS. 5 to 8) and subsequently the user setting is selected from the sub-menu, the user setting screen that is illustrated FIG. 17 is displayed in a pop-up manner.

Provided on the user setting screen are display point-in-time setter 181, image quality setter 182, setting button 183, and cancelation button 184.

Display point-in-time setter 181 is one that sets a point in time of a sales room image that is displayed on the designation point-in-time checking screen (refer to FIG. 7). At this point, a plurality of display points in time can be set. Normally, in an initial state, 7:00, 14:00, and 23:00 that are among important time spans in a store are set to be display points in time.

Image quality setter 182 is one that performs switching on a sales room image (which excludes the enlargement image display screen) that is displayed on image list display unit 75 on the monitoring screen (refer to FIGS. 5 to 8). When the high-quality image mode is set to be off, a low resolution thumbnail image is displayed. When the high-quality image mode is set to be on, a high resolution original-image is displayed.

When setting button 183 is operated, processing that reflects the detail of setting, which is input, in user information in management server 22, and the user setting screen is closed. When cancelation button 184 is operated, the user setting screen is closed without the detail that is input being reflected.

Next, the topic setting screen in the transition situation of the screen that is illustrated in FIG. 4 will be described. FIG. 18 is a descriptive diagram illustrating the topic setting screen.

When the setting is selected from main menu 71 on the monitoring screen (refer to FIGS. 5 to 8) and subsequently the topic setting is selected from the sub-menu, the topic setting screen that is illustrated in FIG. 18 is displayed in a pop-up manner.

The topic setting screen is one for setting a topic that is displayed on the topic display screen (refer to FIG. 19) which is displayed immediately after the login. The topic setting can be performed only in a case where the user is a manager.

Provided on the topic setting screen are invalidity setter 191, title input unit 192, organization selector 193, and topic content input unit 194.

A check box is provided to invalidity setter 191, and at this point, the display of the topic can be set to be invalid. A title of the topic is input into title input unit 192. Organization selector 193 is one that selects a group that is a target on which the topic is displayed, and selects a group with a pull-down menu. The content of the topic, that is, a message that is notified by a manager to the user who belongs to a group, is input into topic content input unit 194.

When setting button 195 is operated, processing that reflects the detail of setting, which is input, topic management information in management server 22 is performed, and the topic setting screen is closed. When cancelation button 196 is operated, the topic setting screen is closed without the detail that is input being reflected.

Next, the topic display screen in the transition situation of the screen that is illustrated in FIG. 4 will be described. FIG. 19 is a descriptive diagram illustrating the topic display screen.

Provided on the topic display screen are organization display unit 201, title display unit 202, topic detail display unit 203, re-display setter 204, and consent button 205.

A group that is a target for a topic is displayed on organization display unit 201. A title of the topic is displayed on title display unit 202. The content of the topic, that is, a message that is notified by a manager to the user who belongs to a group, is displayed on topic detail display unit 203. A check box is provided to re-display setter 204, and re-display of the topic display screen at the time of the login can be stopped during a prescribed stop duration. In a non-check state, the topic display screen is displayed whenever the login is performed. In a case where the manager updates a topic during the stop duration, the topic display screen is displayed.

When consent button 205 is operated, the topic display screen is closed. In a case where the user belongs a plurality of groups, the topic display screen relating to a next group is displayed.

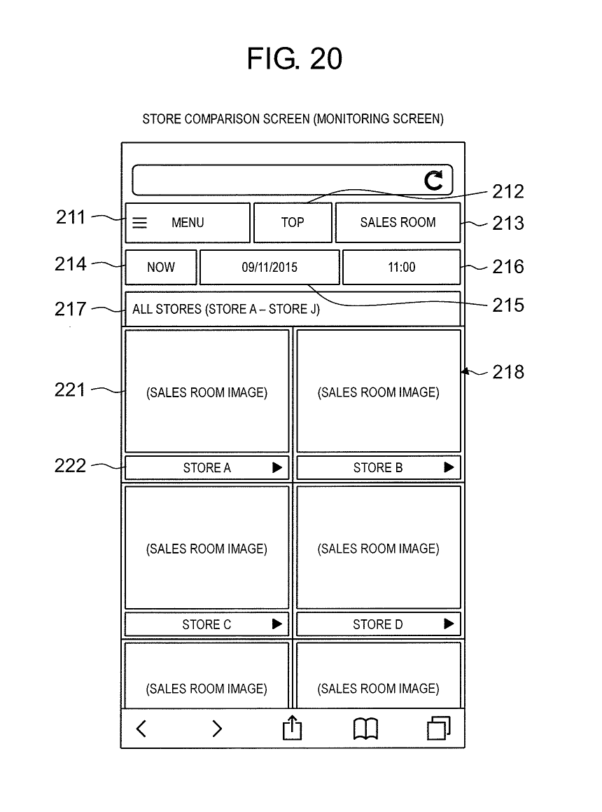

Next, a screen that is displayed on smartphone 4 will be described. FIG. 20 is a descriptive diagram illustrating the monitoring screen (the store list comparison screen) that is displayed on smartphone 4.

Provided on the monitoring screen (the store list comparison screen) are main menu display button 211, top button 212, first selection menu display button 213, NOW button 214, date changing button 215, second selection menu display button 216, size map display unit 217, and image list display unit 218.

When main menu display button 211 is operated, a main menu is displayed. Any one of monitoring, report list, report input, user setting, topic setting, password change, and logout can be selected from the main menu.

When top button 212 is operated, transitioning to the store list comparison screen as the top screen takes place.

When first selection menu display button 213 is operated, a selection menu in accordance with the monitoring screen (the store list comparison screen, the sales room list checking screen, the designation point-in-time checking screen, or the all-day checking screen) is displayed. The selection menu is one that is equivalent to selection menu display unit 74 in the monitoring screen (refer to FIGS. 5 to 8) of PC 3, and selection items on the selection menu varies according to the monitoring screen.

That is, in the case of the store list comparison screen, the designation point-in-time checking screen, and the all-day checking screen, letters “sales room” are displayed on selection menu display button 213. When selection menu display button 213 is operated, sales room selection menu is displayed, and thus a sales room image of every store that is displayed on image list display unit 218 can be changed to that of another sales room. In the case of the sales room list checking screen, letters “store” are displayed on selection menu display button 213. When selection menu display button 213 is operated, a store selection menu is displayed, and thus a sales room image of every store that is displayed on image list display unit 218 can be changed to that of another store.

Further, first selection menu display button 213 is also displayed on the report list screen. In this case, letters “operation” are displayed on selection menu display button 213. When selection menu display button 213 is operated, an operation selection menu is displayed. Any one of the update and the deletion can be selected from the operation selection menu, a report that is displayed on the report list screen can be updated to a recent state, and a report that is displayed on the report list screen can be deleted.

Furthermore, even in the case of smartphone 4, when a sales room image on the monitoring screen (the store list comparison screen, the sales room list checking screen, the designation point-in-time checking screen, or the all-day checking screen) is selected, the enlargement image display screen is displayed.

In the same manner as on the monitoring screen (refer to FIGS. 5 to 8) of PC 3, with NOW button 214, a display date and time can be changed to a current point in time (a recent point in time of the image acquisition). In the same manner as on the monitoring screen (refer to FIGS. 5 to 8) of PC 3, with date changing button 215, a calendar is displayed and a date can be selected.

When second selection menu display button 216 is operated, a selection menu in accordance with the monitoring screen (the store list comparison screen, the sales room list checking screen, the designation point-in-time checking screen, or the all-day checking screen) is displayed. Selection items on the selection menu vary according to the monitoring screen.

That is, in the case of the store list comparison screen and the sales room list checking screen, a display point in time that is currently set is displayed on second selection menu display button 216. When second selection menu display button 216 is operated, a point-in-time selection menu (a selection box) is displayed, and thus the display point in time can be changed with the point-in-time selection menu. In the case of the designation point-in-time checking screen, a display duration (an interval of a week or an interval of a day) that is currently set is displayed on second selection menu display button 216. When second selection menu display button 216 is operated, a display interval selection menu (a selection box) is displayed, and thus, the display duration can be changed with the display interval selection menu. In the case of the all-day checking screen, a display interval (15 minutes, 30 minutes, one hour, or two hours) that is currently set is displayed on second selection menu display button 216. When second selection menu display button 216 is operated, the display interval selection menu (the selection box) is displayed, and thus the display interval can be changed with the display interval selection menu.

In the same manner as on the monitoring screen (refer to FIGS. 5 to 8) of PC 3, size map display unit 217 is one that displays the transition situation of the screen. Buttons for “all stores”, “store name”, “sales room name”, and “details” are displayed according to the monitoring screen (the store list comparison screen, the sales room list checking screen, the designation point-in-time checking screen, or the all-day checking screen). When each button is operated, transitioning to the corresponding monitoring screen takes place.

In the same manner as on the monitoring screen (refer to FIGS. 5 to 8) in PC 3, a plurality of sales room image display units 221 that are arranged side by side vertically and horizontally and description display unit 222 that is positioned under sales room image display unit 221 are provided on image list display unit 218. A sales room image is displayed on sales room image display unit 221. In the case of the store list comparison screen, a store name is displayed on the description display unit 222. In the case of the sales room list checking screen, a sales room name is displayed on the description display unit 222. In the case of the designation point-in-time checking screen and the all-day checking screen, a point in time is displayed on the description display unit 222.

Furthermore, in an example that is illustrated in FIG. 20, two sales room images in the horizontal direction are displayed side by side. The number of sales room images that are arranged in the vertical direction is random, and in the case where the sales room images do not fit into one screen, the scrolling may be performed using the scrolling bar.

The transition of the screen in smartphone 4 is the same as in PC 3. Furthermore, the detail of display on the screen that is displayed in smartphone 4 is approximately the same as in the case of PC 3, but the screen is somewhat small, a slight change may be performed. For example, on the monitoring screen of smartphone 4, a time bar may be omitted. Furthermore, when the report is selected on the report list screen, transitioning to another screen takes place. In the another screen, along with the content of (a date and time, a store name, a subject, and evaluation) of the selected report, a sales room image may be set to be displayed.

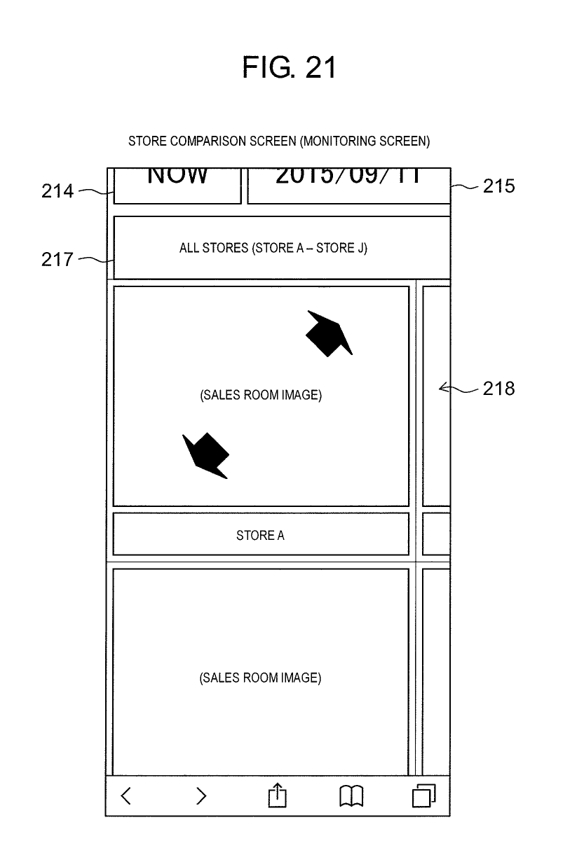

Next, enlargement display of a sales room image on the monitoring screen that is illustrated in FIG. 20 will be described. FIG. 21 is a descriptive diagram illustrating an enlargement display situation of the sales room image on the monitoring screen.

Even in the case of smartphone 4, a user setting screen that is the same as the user setting screen (refer to FIG. 17) in the case of PC 3 is displayed and a high resolution mode can be selected on the user setting screen. When the high resolution mode is selected, a high resolution sales room image (an original image) is always displayed on the monitoring screen.

Furthermore, as illustrated in FIG. 21, the monitoring screen can be displayed in an enlarged manner with a pinch-out operation (an operation of widening a distance between two fingers that comes into contact with a screen). In this case, because a sales room image is displayed at high resolution, the sales room image, although enlarged, can be read as an image with fine detail. Furthermore, a scroll operation (an operation of shifting a finger that comes into contact with a screen) is performed with the display being maintained in an enlarged manner, and a screen is moved. Thus, another sales room image can also be displayed for reading in an enlarged manner.

The operation of displaying a screen in an enlarged manner is not limited to the pinch-out, and known various methods can be employed. For example, with a tap operation (an operation of striking a screen lightly and thus causing contact with the screen for an instant), the display may be performed in an enlarged manner at prescribed magnification.

In the present embodiment, although an enlargement image display screen is not separately displayed by performing an operation of selecting a sales room image, a situation of a sales room can be observed in detail by performing the display in an enlarged manner on the monitoring screen as is. Thus, the operability can be increased. An effect of this type of the display in an enlarged manner is the same as in the case of PC 3.

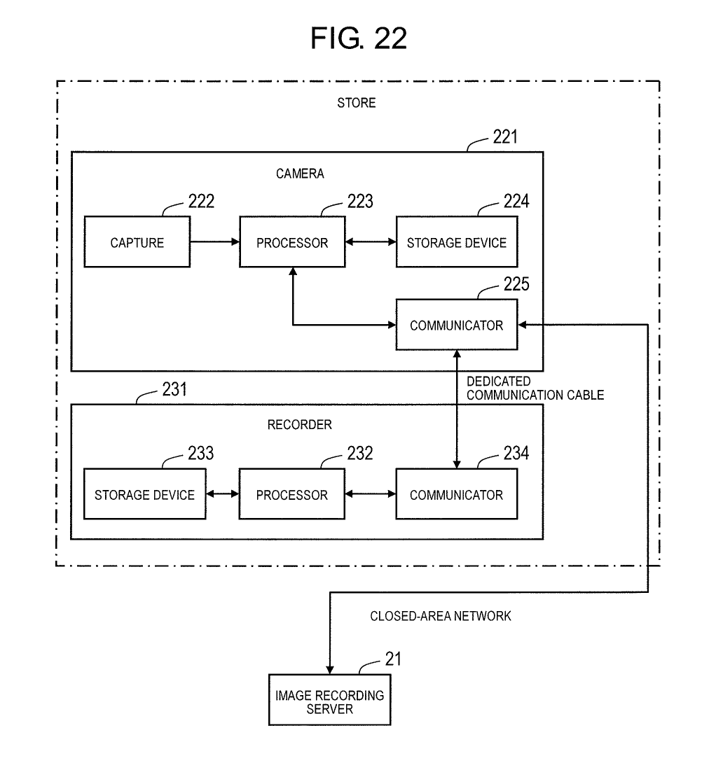

Next, a modification example of the facility operation support system will be described. FIG. 22 is a block diagram illustrating schematic configurations of camera 221 and recorder 231 according to the modification example of the facility operation support system.

In the modification example, in the same manner as in the embodiment (refer to FIG. 1) described above, camera 221 is set to be a so-called network camera (an IP camera) that is connectable to a network, but camera 221 is configured in such a manner that an output in two systems is possible, and is connected to recorder 231 through a dedicated communication cable (for example, a coaxial cable). Record 231 is one that is provided for application in crime prevention and disaster prevention. In record 231, security is ensured.

Camera 221 includes capture 222, processor 223, storage device 224, and communicator 225.

Capture 222 and storage device 224 are the same as in the embodiment (refer to FIG. 3) described above. In the same manner as in the embodiment (refer to FIG. 1) described above, processor 223 performs the moving object removal processing (the background image generation processing) on the captured image that is output by capture 222, but the unprocessed image, as is, which is output from capture 222, can be input into communicator 225. Communicator 225 possibly performs the output in two systems. Not only does communicator 225 transmit the reading still image that results from removing the moving object, to image recording server 21 through the closed-area network, but also transmits the unprocessed image that results from not removing the moving object, to recorder 231 through a dedicated communication cable.

Recorder 231 includes processor 232, storage device 233, and communicator 234.

Communicator 234 receives the unprocessed image that is transmitted from camera 221. Processor 232 performs control that stores the unprocessed image, which is received in the communicator 234, in storage device 233. Storage device 233 stores a program that is executed in processor 232, and the unprocessed image that is received in communicator 234. As storage device 233, a high-capacity storage device, such as a hard disk driver, is employed in such a manner that images are storable for a long time.

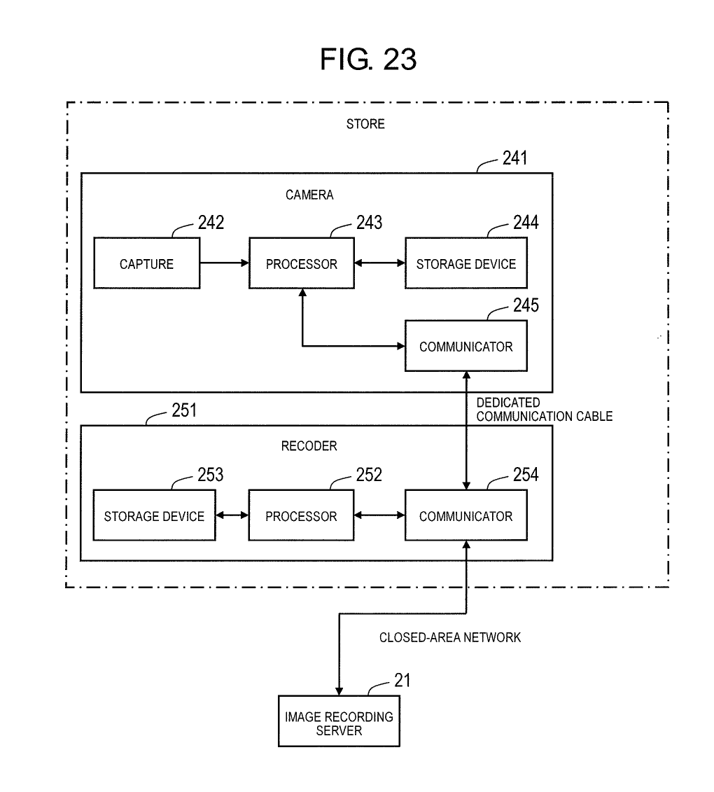

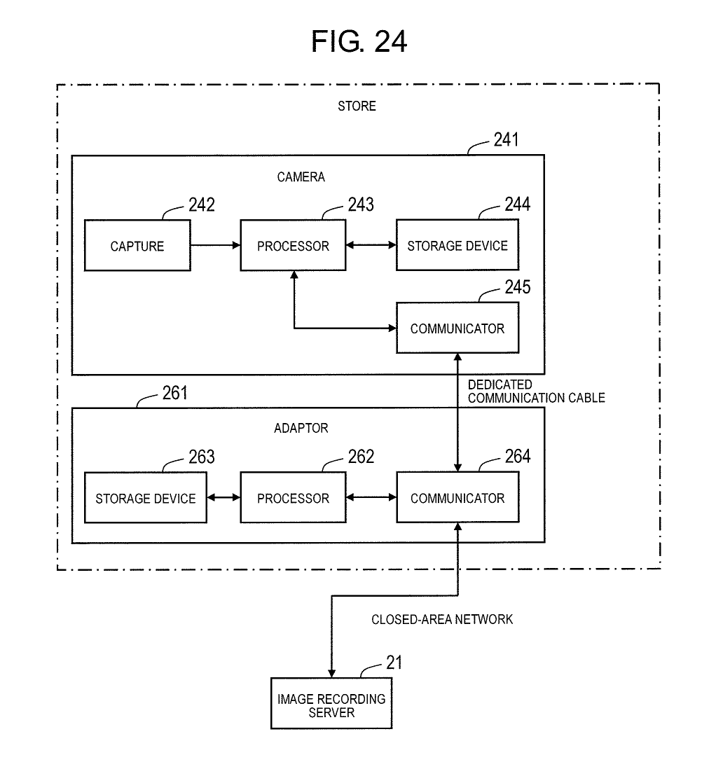

Next, another modification example of the facility operation support system will be described. FIG. 23 is a block diagram illustrating schematic configurations of camera 241 and recorder 251 according to the modification example of the facility operation support system. FIG. 24 is a block diagram illustrating schematic configurations of camera 241 and adaptor 261 according to the modification example of the facility operation support system.

In the embodiment (refer to FIG. 1) described above, camera 1 is set to be a so-called network-connectable camera (an IP camera) that is connectable to a network, but in the modification example that is illustrated in FIGS. 23 and 24, camera 241 is connected to recorder (a facility image storage device) 251 or adaptor (facility image output control device) 261 through a dedicated communication cable (for example, a coaxial cable). Recorder 251 and adaptor 261 are configured to be network-connectable, and is connected to image recording server 21 through the closed-area network.

Camera 241 includes capture 242, processor 243, storage device 244, and communicator 245.

Capture 242 and storage device 244 are the same as in the embodiment (refer to FIG. 3) described above. Processor 243 does not have a function of performing the moving object removal processing (the background image generation processing), and inputs the unprocessed image, as is, which is output from capture 242, into communicator 245. Communicator 245 transmits the unprocessed image to recorder 251 or adaptor 261 through a dedicated communication cable.

In the same manner as in the example that is illustrated in FIG. 22, recorder 251 that is illustrated in FIG. 23 includes processor 252, storage device 253, and communicator 254. However, processor 252 performs the moving object removal processing (the background image generation processing) on the unprocessed image that is received in communicator 254 differently than in the example that is illustrated in FIG. 22. The moving object removal processing is the same as the processing that is performed in processor 32 of camera 1 in the embodiment described above. Communicator 254 transmits the processed image that is generated in processor 252, to image recording server 21. The storage device 253 is the same as in the example that is illustrated in FIG. 22.

Adaptor 261 that is illustrated in FIG. 24 includes processor 262, storage device 263, and communicator 264.

Communicator 264 and processor 262 are the same as in recorder 251 that is illustrated in FIG. 23. Storage device 263 stores a program that is executed in processor 262. However, storage device 263 temporarily stores the unprocessed image for processing in the processor 262 and does not store an image for a long period of time, differently than in recorder 251. Because of this, as storage device 263, a low-capacity storage device is employed.

An example of the technology that is disclosed in the present application, the embodiment is described above. However, the technology is not limited to this, and can also apply to an embodiment that results from amendment, substitution, addition, and omission, and the like. Furthermore, it is also possible that a combination of the constituent elements which are described above in the embodiment described above is set to be a new embodiment.

For example, in the embodiment described above, an example of a retail store such as the convenience store is described, but a wide application in a financial institution such as a bank, a lodging facility such as a hotel, or various facilities that provide a commodity or a service to a customer can be found.

Furthermore, in the embodiment described above, the PC or the smartphone is given as examples of the user terminal device, but the user terminal device is not limited to these and a tablet terminal is also possible. In the tablet terminal, the same screen display as in the PC may be performed.

Furthermore, in the embodiment described above, cloud computing system 2 is set to be configured to include three information processing devices, that is, image recording server 21, management server 22, and delivery server 23, but a function of each server may be set to be realized on one information processing device.

Furthermore, in the embodiment described above, as illustrated in FIG. 2, camera 1 is set to be an omnidirectional camera with a fish-eye lens that has a photographing range of 360 degrees, but a camera with a prescribed angle of view, called a box camera is also possible.

### INDUSTRIAL APPLICABILITY

A facility imaging device, a facility image collecting device, a facility image storage device, and a facility image output control device according to the present disclosure achieves an effect in which a load of traffic on a network when collecting images that result from image-capturing the insides of a plurality of facilities is reduced, and additionally in which a risk that an unprocessed image will leak out is removed and images that are privacy-protected can be efficiently collected, and are useful as a facility imaging device that provides an image that results from image-capturing the inside of a facility, to a facility image collecting device through a network, the facility image collecting device that acquires the image that result from image-capturing the inside of the facility, through the network and that stores the image, a facility image storage device that not only stores an image which is output from the facility imaging device that image-captures the inside of the facility, but also outputs the image to the facility image collecting device through the network, a facility image output control device that is connected to the facility imaging device which image-captures the inside of the facility, and controls image output to the facility image collecting device through the network, and the like, respectively.

Furthermore, a facility operation support device, a user terminal device, and a facility operation support method according to the present disclosure achieves an effect in which, even in a case where the number of stores or the number of sales rooms increases, a plurality of users such as supervisors or owners that manage many stores can efficiently check a situation of the inside of a store from anywhere and can conduct reasonably the business of improving store operation, are useful as a facility operation support device that supports business of a user who operates a facility which provides a commodity or a service to a customer, a user terminal device, a facility operation support method, and the like, respectively.

### REFERENCE MARKS IN THE DRAWINGS

1 CAMERA (FACILITY IMAGING DEVICE)

2 CLOUD COMPUTER SYSTEM (FACILITY OPERATION SUPPORT DEVICE)

3 PC (USER TERMINAL DEVICE)

4 SMARTPHONE (USER TERMINAL DEVICE)

21 RECORDING SERVER (FACILITY IMAGE COLLECTING DEVICE, IMAGE STORAGE, INFORMATION PROCESSING DEVICE)

22 MANAGEMENT SERVER (INFORMATION PROCESSING DEVICE)

23 DELIVERY SERVER (INFORMATION PROCESSING DEVICE)

31 CAPTURE

32 PROCESSOR

33 STORAGE DEVICE

34 COMMUNICATOR

41 PROCESSOR

42 STORAGE DEVICE

43 COMMUNICATOR

72 DATE AND TIME INPUT UNIT

81 NOW BUTTON

82 DATE CHANGING UNIT

82a DATE DISPLAY UNIT

82b, 82c ARROW BUTTON

83 POINT-IN-TIME CHANGING UNIT

83a POINT-IN-TIME DISPLAY UNIT

83b, 83c ARROW BUTTON

83d TIME BAR

93 STORE-BASED IMAGE LIST

94 SALES ROOM SELECTION MENU

95 SALES ROOM-BASED IMAGE LIST

96 STORE SELECTION MENU

97 DATE-BASED IMAGE LIST

98 POINT-IN-TIME-BASED IMAGE LIST

251 RECORDER (FACILITY IMAGE STORAGE DEVICE)

252 PROCESSOR

253 STORAGE DEVICE

254 COMMUNICATOR (RECEIVER, TRANSMITTER)

261 ADAPTOR (FACILITY IMAGE OUTPUT CONTROL DEVICE)

262 PROCESSOR

264 COMMUNICATOR (RECEIVER, TRANSMITTER)

1. A facility imaging device that provides an image which results from image-capturing the inside of a facility, to a facility image collecting device through a network, comprising:
a capture that image-captures the inside of the facility and sequentially outputs the captured images that temporally follow one another;
a processor that performs image processing on the captured images and outputs the processed images; and
a communicator that transmits the processed images to the facility image collecting device through the network,
wherein, whenever the captured image is input from the capture, the processor updates dominant image information and generates a reading still image that results from removing a moving object, as the processed image, and
wherein the communicator transmits the reading still image at a prescribed timing.

2. The facility imaging device of claim 1,
wherein the dominant image information is color information on a per-pixel basis.

3. The facility imaging device of claim 1,
wherein the communicator transmits the reading still image according to an image transmission request that is transmitted from the facility image collecting device at a timing that is common to other facility imaging devices.

4. The facility imaging device of claim 1,
wherein the communicator not only outputs the reading still image that results from removing the moving object to an image storage device for facility operation support, but also outputs an unprocessed image that result from not removing the moving object to another image storage device in which security is ensured.

5. A facility image collecting device that acquires an image which results from image-capturing the inside of a facility, from a facility imaging device through a network and that stores the acquired image, comprising:
a communicator that receives a reading still image which is transmitted from the facility imaging device;
a storage device that stores the reading still image; and
a processor that controls a timing at which the reading still image is acquired from the facility imaging device,
wherein the communicator makes an image transmission request periodically at a prescribed timing under the control of the processor, and receives the reading still image that is transmitted from the facility imaging device according to the image transmission request.

6. The facility image collecting device of claim 5,
wherein, when acquisition of the reading still image fails at the timing, the communicator repeatedly makes the image transmission request for a duration up to the next timing until the acquisition of the reading still image succeeds.

7. A facility image storage device that not only stores an image which is output from a facility imaging device that image-captures the inside of a facility, but also outputs the image to a facility image collecting device through a network, comprising:
a receiver that receives captured images that temporally follow one another, which are sequentially output from the facility imaging device;
a storage device that stores the captured images;
a processor that performs image processing on the captured images and outputs the processed images; and
a transmitter that transmits the processed mages to the facility image collecting device through the network,
wherein, whenever the captured image is input from the facility imaging device, the processor updates dominant image information and generates a reading still image that results from removing a moving object, as the processed image, and
wherein the transmitter transmits the reading still image at a prescribed timing.

8. A facility image output control device that is connected to a facility imaging device which image-captures the inside of a facility and that controls image output to a facility image collecting device through a network, comprising:
a receiver that receives captured images that temporally follow one another, which are sequentially output from the facility imaging device;
a processor that performs image processing on the captured images and outputs processed images; and
a transmitter that transmits the processed images to the facility image collecting device through the network,
wherein, whenever the captured image is input from the facility imaging device, the processor updates dominant image information and generates a reading still image that results from removing a moving object, as the processed image, and
wherein, the transmitter transmits the reading still image at a prescribed timing.

9. A facility operation support device that supports business of a user who operates a facility which provides a commodity or a service to a customer, comprising:
an image storage that stores an area image of each area in the facility;
a management server that manages the area image; and
a delivery server that delivers a reading screen including the area image to a user terminal device,
wherein the delivery server generates the reading screen which includes a facility-based image list in which the area image of every facility relating to the area that is shared is shown side by side with a facility name, and an area selection menu for changing the area in the facility-based image list, and delivers the generated reading screen to the user terminal device.

10. The facility operation support device of claim 9,
wherein the delivery server displays a plurality of date and time input units in which input methods are different from each other on the reading screen and causes a user to input a display date and time of the area image in the facility-based image list using the plurality of date and time input boxes.

11. The facility operation support device of claim 10,
wherein the date and time input unit uses at least two input methods, among a calendar input method that designates a date and time using a calendar, a date and time advancing and postponing input method that changes a date and time at a prescribed interval, a schedule input method that designates a date and time in a position in a time axis direction in a time scale, and a current date and time input method that performs a change to a current date and time.

12. The facility operation support device of claim 9,
wherein, based on a user operation that selects the facility from the facility-based image list, the delivery server generates a reading screen that includes an area-based image list in which the area image in the same facility is shown side by side with the area name, and a facility selection menu for changing the facility in the area-based image list, and delivers the generated reading screen to the user terminal device.

13. The facility operation support device of claim 12,
wherein, based on a user operation that selects the area from the area-based image list, the delivery server generates a reading screen that includes a date-based image list in which the area images on each date during a prescribed duration relating to the selected area are shown side by side with each other, and an area selection menu for changing the area in the date-based image list, and delivers the generated reading screen to the user terminal device.

14. The facility operation support device of claim 13,
wherein the area images at a point in time that is designated in advance are displayed side by side with each other on a per-date basis in the date-based image list.

15. The facility operation support device of claim 13,
wherein, based on a user operation that selects a date from the date-based image list, the delivery server generates a reading screen that includes a point-in-time-based image list in which the area images at each point in time on the selected date is shown side by side with each other in a time sequence, and an area selection menu for changing the area in the point-in-time-based image list, and delivers the generated reading screen to the user terminal device.

16. The facility operation support device of claim 9,
wherein, based on the user operation that selects a high-quality image mode, the delivery server generates the reading screen that includes the area image of high resolution and delivers the generated reading screen to the user terminal device.

17. The facility operation support device of claim 1,
wherein the image storage acquires the reading still image that results from removing the moving object from the image which results from image-capturing the inside of the facility, periodically at a prescribed timing from the facility imaging device, generates the area image from the reading still image and stores the generated area image, and
wherein the delivery server delivers the area image at a point in time that is designated by the user to user terminal device.

18. A user terminal device that displays a screen based on information which is delivered from a facility operation support device that supports business of a user who operates a facility that provides a commodity or a service to a customer,
wherein a reading screen that includes a facility-based image list in which an area image of every facility relating to an area that is shared is shown side by side with a facility name and an area selection menu for changing the area in the facility-based image list is displayed.

19. A facility operation support method that supports business of a user who operates a facility which provides a commodity or a service to a customer, using an information processing device,
wherein the information processing device stores an area image of each area in the facility, generates a reading screen which includes a facility-based image list in which an area image of every facility relating to the area that is shared is shown side by side with a facility name, and an area selection menu for changing the area in the facility-based image list, and delivers the generated reading screen to a user terminal device.
